(19) United States
(12) Patent Application Publication
(10) Pub. No.: US 2023/0166767 A1
(43) Pub. Date: Jun. 1, 2023

(54) PATH CHECKING DEVICE, PATH CHECKING METHOD AND VEHICLE CONTROL METHOD

(71) Applicant: DENSO CORPORATION, Kariya-city (JP)

(72) Inventors: JINGYU XIANG, Nisshin-city (JP); SHOHEI FUJII, Nisshin-city (JP); KEISUKE SHINODA, Nisshin-city (JP); HIROYUKI OHSAWA, Kariya-city (JP)

(21) Appl. No.: 18/159,345

(22) Filed: Jan. 25, 2023

Related U.S. Application Data
(63) Continuation of application No. PCT/JP2021/027802, filed on Jul. 27, 2021.

(30) Foreign Application Priority Data
Jul. 29, 2020 (JP) 2020-128558

(51) Int. Cl. B60W 60/00; B60W 30/095

(52) U.S. Cl. CPC B60W 60/0015; B60W 30/0956; B60W 2554/4046; B60W 2554/80

(57) ABSTRACT

A path checking device for a subject vehicle includes: a safety distance setting unit that sets a minimum safety distance for a surrounding vehicle in order for the subject vehicle to avoid closely approaching the obstacle; an emergency control unit that executes emergency control for the subject vehicle when a distance between the subject vehicle and the surrounding vehicle is less than the safety distance; and a caution distance setting unit that sets a caution distance for the subject vehicle to the surrounding vehicle. The emergency control unit is further configured to: determine whether the subject vehicle is traveling with the caution distance; and control the travel control unit to increase a distance from the subject vehicle to the surrounding vehicle to exceed the caution distance when the distance from the subject vehicle to the surrounding vehicle is less than the caution distance.

### CROSS REFERENCE TO RELATED APPLICATIONS

This application is a continuation application of International Patent Application No. PCT/JP2021/027802 filed on Jul. 27, 2021, which designated the U.S. and claims the benefit of priority from Japanese Patent Application No. 2020-128558 filed on Jul. 29, 2020. The entire disclosure of all of the above application is incorporated herein by reference.

### TECHNICAL FIELD

The disclosure in this specification relates to a path checking device, a path checking method, and a vehicle control method for controlling travel of a subject vehicle to keep a safety distance.

### BACKGROUND ART

In automated-driving, a safety distance is calculated as a standard for evaluating safety, and a minimum safety distance is maintained between the subject vehicle and other vehicles, pedestrians, or the like.

### SUMMARY

One aspect of the present disclosure is a path checking device for a subject vehicle including a path generation unit that generates a driving plan for the subject vehicle to travel by automated-driving and a travel control unit that controls traveling of the subject vehicle according to the driving plan. The path checking device includes: a safety distance setting unit that is configured to set a minimum safety distance for the subject vehicle to an obstacle in order for the subject vehicle to avoid closely approaching the obstacle; an emergency control unit that is configured to: determine whether the subject vehicle is traveling with the safety distance; and execute emergency control for the subject vehicle that is different from normal control according to the driving plan when a distance between the subject vehicle and the obstacle is less than the safety distance; and a caution distance setting unit that is configured to set a caution distance for the subject vehicle to a surrounding vehicle that is travelling around the subject vehicle when the obstacle is the surrounding vehicle, the caution distance being greater than the safety distance. The emergency control unit is further configured to: determine whether the subject vehicle is traveling with the caution distance; and control the travel control unit to increase a distance from the subject vehicle to the surrounding vehicle to exceed the caution distance when the distance from the subject vehicle to the surrounding vehicle is less than the caution distance.

### BRIEF DESCRIPTION OF DRAWINGS

FIG. 1 is a block diagram depicting a vehicle system according to a first embodiment.

FIG. 2 is a block diagram showing a path checking unit.

FIG. 3 is a diagram for explaining a caution distance from a preceding vehicle.

FIG. 4 is a diagram showing an RSS model with a formula.

FIG. 5 is a diagram for explaining derivation of the formula shown in FIG. 4.

FIG. 6 is a diagram for explaining a caution distance to a vehicle traveling on a right (left) side.

FIG. 7 is a flowchart showing a process of setting the caution distance.

FIG. 8 is a flowchart showing a process of finishing setting the caution distance.

FIG. 9 is a flowchart showing a process of setting the caution distance at a parking lot.

FIG. 10 is a flowchart showing a process of finishing setting the caution distance at the parking lot.

FIG. 11 is a flowchart showing a termination process of an emergency stop plan.

FIG. 12 is a conceptual diagram showing a speed difference Δv of a preceding vehicle for each observation time.

FIG. 13 is a diagram showing TTC and a lower limit of a stabile range.

### DESCRIPTION OF EMBODIMENTS

To begin with, a relevant technology will be described only for understanding the following embodiments. In a typical navigation system, an emergency stop mode is implemented in which the subject vehicle makes an emergency stop when another vehicle invades the safety distance of the subject vehicle during automated-driving of the subject vehicle. The safety distance is calculated using the other vehicle's speed and acceleration. However, if the other vehicle accelerates/decelerates irregularly, the value of the safety distance may not be stable. Therefore, if the other vehicle accelerates or decelerates irregularly, the safety distance may be invaded temporarily. As a result, unnecessary emergency control such as unnecessary emergency stop may be often performed.

One of objectives of the present disclosure is therefore to provide a path checking device, a path checking method, and a vehicle control method that are designed to avoid executing unnecessary emergency control.

A first aspect of the present disclosure is a path checking device for a subject vehicle including a path generation unit that generates a driving plan for the subject vehicle to travel by automated-driving and a travel control unit that controls traveling of the subject vehicle according to the driving plan. The path checking device includes: a safety distance setting unit that is configured to set a minimum safety distance for the subject vehicle to an obstacle in order for the subject vehicle to avoid closely approaching the obstacle; an emergency control unit that is configured to: determine whether the subject vehicle is traveling with the safety distance; and execute emergency control for the subject vehicle that is different from normal control according to the driving plan when a distance between the subject vehicle and the obstacle is less than the safety distance; and a caution distance setting unit that is configured to set a caution distance for the subject vehicle to a surrounding vehicle that is travelling around the subject vehicle when the obstacle is the surrounding vehicle, the caution distance being greater than the safety distance. The emergency control unit is further configured to: determine whether the subject vehicle is traveling with the caution distance; and control the travel control unit to increase a distance from the subject vehicle to the surrounding vehicle to exceed the caution distance when the distance from the subject vehicle to the surrounding vehicle is less than the caution distance.

According to the first aspect, the caution distance setting unit sets the caution distance as a distance to be kept between the subject vehicle and the surrounding vehicle. The caution distance is a distance greater than the safety distance. Then, the emergency control unit is further configured to: determine whether the subject vehicle is traveling with the caution distance; and control the travel control unit to increase a distance from the subject vehicle to the surrounding vehicle to exceed the caution distance when the distance from the subject vehicle to the obstacle is less than the caution distance. Accordingly, if a vehicle-to-vehicle distance between the subject vehicle and the surrounding vehicle decreases to be less than the caution distance, deceleration control or steering control is performed to expand the vehicle-to-vehicle distance without performing an emergency stop. Therefore, even if the surrounding vehicle repeats acceleration and deceleration due to unstable traveling state, for example, and even if the caution distance is temporarily invaded, the vehicle-to-vehicle distance can be increased to be greater than the caution distance without making an emergency stop. Therefore, it is possible to avoid executing unnecessary emergency control.

A second aspect of the present disclosure is a path checking device for a subject vehicle including a path generation unit that generates a driving plan for the subject vehicle to travel by automated-driving and a travel control unit that controls driving of the subject vehicle according to the driving plan. The path checking device includes: a safety distance setting unit that is configured to set a minimum safety distance for the subject vehicle to an obstacle in order for the subject vehicle to avoid closely approaching the obstacle; and an emergency control unit that is configured to: determine whether the subject vehicle is traveling with the safety distance; and execute emergency control for the subject vehicle that is different from normal control according to the driving plan when a distance from the subject vehicle to the obstacle is less than the safety distance. The emergency control unit is further configured to: determine whether the subject vehicle is traveling with the safety distance when executing the driving plan newly generated by the path generation unit while executing the emergency control; and control the travel control unit to terminate the emergency control and execute the newly generated driving plan when the subject vehicle is determined to be traveling with the safety distance.

According to the second aspect, the emergency stop unit determines whether the subject vehicle would be able to travel with the set safety distance if the driving plan newly generated by the path generation unit is executed during execution of the emergency control. Then, the emergency stop unit controls the travel control unit to avoid performing the emergency control and execute the newly generated driving plan when the subject vehicle is determined to be able to travel while ensuring the safety distance. As a result, even if the emergency control is being executed, it is possible to return back to normal traveling by executing the new driving plan when the safety distance can be secured. Therefore, even if the traveling state of the surrounding vehicle is unstable and the surrounding vehicle repeatedly accelerates and decelerates and, as a result, the safety distance is temporarily invaded, the vehicle-to-vehicle distance can be increased to ensure the safety distance during execution of the emergency control. Therefore, the subject vehicle can continue to travel with the safety distance. Therefore, it is possible to avoid executing unnecessary emergency control.

A third aspect of the present disclosure is a path checking method executed by a processor for a subject vehicle that travels according to a driving plan that is set for the subject vehicle to travel by automated-driving. The method includes: setting a minimum safety distance for the subject vehicle to an obstacle in order for the subject vehicle to avoid closely approaching the obstacle; determining whether the subject vehicle is traveling with the safety distance; executing emergency control for the subject vehicle that is different from normal control according to the driving plan when a distance from the subject vehicle to the obstacle is less than the safety distance; setting a caution distance for the subject vehicle to a surrounding vehicle that is travelling around the subject vehicle when the obstacle is the surrounding vehicle, the caution distance being greater than the safety distance; determining whether the subject vehicle is travelling with the caution distance; and controlling the travel control unit to increase a distance from the subject vehicle to the surrounding vehicle to exceed the caution distance when the distance from the subject vehicle to the surrounding vehicle is less than the caution distance.

A fourth aspect of the present disclosure is a path checking method executed by a processor for a subject vehicle that travels according to a driving plan that is set for the subject vehicle to travel by automated-driving. The method includes: setting a minimum safety distance for the subject vehicle to an obstacle in order for the subject vehicle to avoid closely approaching the obstacle; determining whether the subject vehicle is traveling with the safety distance; executing emergency control for the subject vehicle that is different from normal control according to the driving plan when a distance from the subject vehicle to the obstacle is less than the safety distance; determining whether the subject vehicle would be able to travel with the safety distance if the driving plan that is newly generated is executed during execution of the emergency control; and terminating the emergency control and executing the newly generated driving plan when the subject vehicle is determined to be able to travel with the safety distance.

According to the third and fourth aspects, execution of unnecessary emergency control can be avoided.

A fifth aspect of the present disclosure is a vehicle control method executed by a processor for a subject vehicle that travels according to a driving plan that is set for the subject vehicle to travel by automated-driving. The method includes: setting a safety envelope as a condition for the subject vehicle to perform a proper response to an obstacle to maintain a predetermined level of risk; determining whether a current behavior of the obstacle is reasonably foreseeable; and setting a stabilization condition to reduce a time instability of the safety envelope when the current behavior of the obstacle is not reasonably foreseeable.

According to the fifth aspect, execution of unnecessary emergency control can be avoided.

The following describes embodiments for carrying out the present disclosure with reference to the drawings. In each embodiment, a part corresponding to the part described in the preceding embodiment may be denoted by the same reference numeral or a reference numeral with one character added to a preceding reference numeral; thereby, redundant explanation may be omitted. In each embodiment, when only part of the configuration is described, the other part of the configuration can be the same as that in a preceding embodiment. The present disclosure is not limited to combinations of embodiments which combine parts that are explicitly described as being combinable. As long as no problems are present, the various embodiments may be partially combined with each other even if not explicitly described.

### First Embodiment

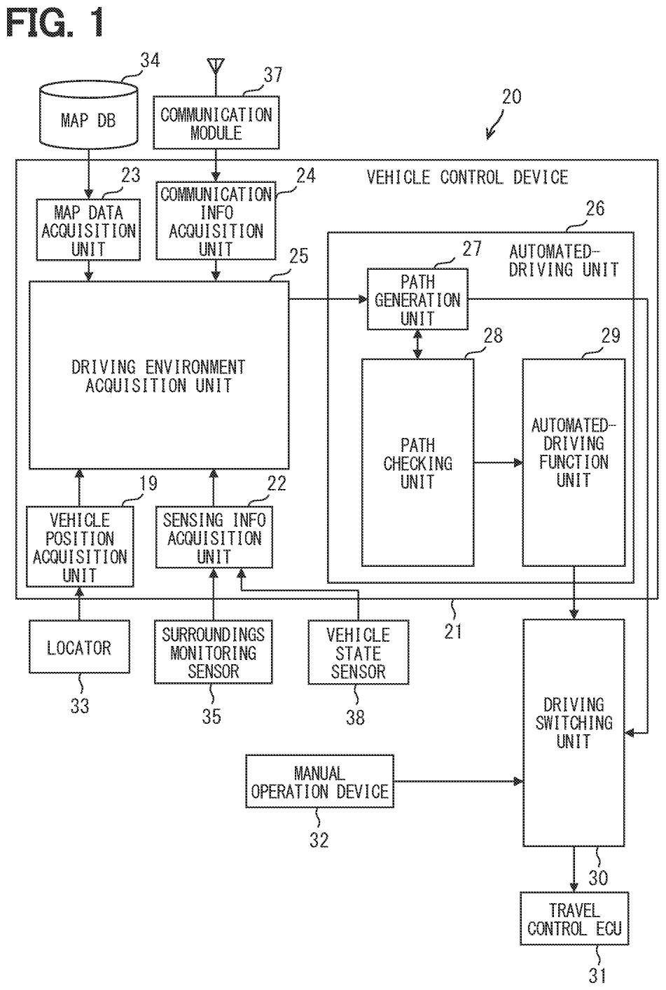

Hereinafter, a first embodiment of the present disclosure will be described with reference to FIGS. 1 to 11. A vehicle system 20 shown in FIG. 1 is used for a vehicle configured to perform an automated-driving (hereinafter referred to as an automated-driving vehicle). As depicted in FIG. 1, the vehicle system 20 includes a vehicle control device 21, a travel control electronic control unit (Electronic Control Unit: abbreviated to ECU) 31, a locator 33, a map database 34, a surroundings monitoring sensor 35, a communication module 37, a vehicle state sensor 38, a manual operation device 32, and a driving switching unit 30. Although the vehicle using the vehicle system 20 is not necessarily limited to an automobile, hereinafter, an example using the automobile will be described.

First, the automated-driving vehicle will be described. The automated-driving vehicle may be a vehicle capable of performing automated-driving as described above. The degree of the automated-driving (hereinafter, referred to as an automation level) includes multiple levels as defined by SAE, for example. According to the SAE definition, for example, the automation levels are categorized into the following levels.

Level 0 is a level where the driver performs all driving tasks without any intervention of the system. The driving tasks include, for example, a steering control, an acceleration, and a deceleration. The level 0 corresponds to so-called manual driving using a manual operation device 32. Level 1 is a level where the system assists the steering control or the acceleration and deceleration. Level 2 is a level where the system assists the steering control, the acceleration and deceleration. Each of the levels 1 and 2 corresponds to so-called driving assistance.

The level 3 is a level where the system performs all driving tasks in a certain location, such as a highway, and the driver performs driving in an emergency. In the level 3, the driver must be able to respond quickly when the system requests for a driver change. The level 3 corresponds to so-called conditional automated-driving. Level 4 is a level where the system is capable of performing all driving tasks, except under a specific circumstance, such as an unsupported road, an extreme environment, and the like. The level 4 corresponds to so-called highly automated driving. Level 5 is a level where the system is capable of performing all driving tasks in any situation. The level 5 corresponds to so-called fully automated-driving. The levels 3-5 correspond to so-called automated-driving. The driving task here may be a dynamic driving task (DDT).

The automated-driving vehicle of the present embodiment may be, for example, an automated-driving vehicle with an automation level of level 3, or an automated-driving vehicle with an automation level of level 4 or higher. The automation level may be switchable. In this embodiment, it is possible to switch between automated-driving at automation level 3 or higher and manual driving at level 0. Switching from automation level 3 to automation level 2 and switching from automation level 3 to automation level 1 may also be allowed. If automation levels 2, 1 are possible, it may be possible to switch between automation levels 2, 1, 0.

Next, the configuration of each element will be described. The locator 33 includes a GNSS (Global Navigation Satellite System) receiver and an inertial sensor. The GNSS receiver is configured to receive positioning signals from multiple positioning satellites. The inertial sensor includes a gyro sensor and an acceleration sensor, for example. The locator 33 sequentially measures a vehicle position of the subject vehicle by combining the positioning signals received by the GNSS receiver and the measurement results of the inertial sensor. The vehicle position may be represented by, for example, coordinates of latitude and longitude. The vehicle position may be measured using a travel distance obtained from signals sequentially output from a vehicle speed sensor mounted in the vehicle.

The map database 34 is a nonvolatile memory and stores map data such as link data, node data, road shapes, buildings and the like. The link data includes various data such as a link ID that identifies the link, a link length that indicates the length of the link, a link direction, a link travel time, a link shape, node coordinates between the start and end of the link, and road attributes. As one example, the link shape may include a coordinate sequence representing coordinate positions of shape interpolation points representing a shape formed of both ends of the link and a position between the both ends. The road attributes include a road name, a road type, a road width, lane number information indicating the number of lanes, a speed regulation value, and the like. The node data includes a various pieces of data such as a node ID in which a unique number is assigned to each node on a map, node coordinates, a node name, a node type, a connection link ID in which a link ID of a link connected to the node is described, and the like. The link data may be subdivided by lane, that is, by road line, in addition to by road section.

From the lane number information and/or the road type, it is possible to determine whether a road section, i.e., a link, corresponds to a road with multiple lanes, a single lane, or a two-way road with no center line. The two-way roads without a central line do not include one-way roads. Note that the center line can also be called a central line. The two-way road without a center line here refers to a two-way road without a center line among general roads other than highways and motorways.

The map data may include a three-dimensional map including feature points of road shapes and buildings. When the three-dimensional map including the feature points of the road shapes and buildings is used as the map data, the locator 33 may be configured to identify the subject vehicle position using the detection results of a LIDAR (Light Detection and Ranging/Laser Imaging Detection and Ranging) configured to detect the feature points of the road shapes and the buildings or the surroundings monitoring sensor 5 such as a surroundings monitoring camera. The three-dimensional map may be generated by REM (Road Experience Management) based on captured images.

The surroundings monitoring sensor 35 is an autonomous sensor that monitors a surroundings environment of the subject vehicle. As one example, the surroundings monitoring sensor 35 recognizes moving objects such as pedestrians, animals other than human, and moving bodies such as vehicles other than the subject vehicle, and static objects such as guardrails, curbs, trees, and fallen objects on the road. The surroundings monitoring sensor 35 further detects a road surface marking such as a traffic lane marking around the subject vehicle. For example, the surroundings monitoring sensor 35 may be a surroundings monitoring camera that captures an image of predetermined range around the subject vehicle. The surroundings monitoring sensor 35 may be a distance measuring sensor that emits a scanning wave toward a predetermined range around the subject vehicle. For example, the distance measuring sensor may be a millimeter wave radar, a sonar, or a lidar.

The vehicle state sensor 38 is a sensor group for detecting various states of the vehicle. The vehicle state sensor 38 includes a vehicle speed sensor, a steering sensor, an acceleration sensor, a yaw rate sensor, and the like. The vehicle speed sensor detects a vehicle speed of the own vehicle. The steering sensor detects a steering angle of the subject vehicle. The acceleration sensor detects the acceleration in a front rear direction of the subject vehicle and the acceleration in a lateral direction of the subject vehicle. The acceleration sensor may also detect a deceleration of the subject vehicle, that is, a negative acceleration. The yaw rate sensor detects an angular velocity of the own vehicle.

The communication module 37 performs vehicle-to-vehicle communication, which is transmission and reception of information, via wireless communication with the communication modules 37 of the vehicle systems 20 mounted in vehicles surrounding the subject vehicle. The communication module 37 may transmit and receive information via wireless communications with roadside devices installed on roadsides. In this case, the communication module 37 may receive information of the surrounding vehicle transmitted from the communication module 37 of the vehicle system 20 mounted in the surrounding vehicle around the subject vehicle via the roadside device.

Further, the communication module 37 may perform wider-area communication by transmitting and receiving information to and from a center outside of the subject vehicle via wireless communications. When vehicles transmit and receive information to each other via a center by wide-area communication, by transmitting and receiving information including vehicle positions, the center may control the communication using the vehicle positions such that vehicles within a certain range can share the information with each other. In the following description, the communication module 37 receives information about vehicles around the subject vehicle by at least one of vehicle-to-vehicle communication, road-to-vehicle communication, and wide-area communication.

Alternatively, the communication module 37 may receive map data distributed from an external server that is configured to distribute map data, for example, through wide-area communication and may store the received map data in the map database 34. In this case, the map database 34 may be a volatile memory, and the communication module 37 may sequentially acquire the map data of an area corresponding to the subject vehicle position.

The manual operation device 32 is a device manually operated by a driver to drive the vehicle, and includes a steering wheel, an accelerator pedal, and a brake pedal. The manual operation device 32 outputs an operation amount operated by the driver to the driving switching unit 30. The operation amount includes an accelerator operation amount, a brake operation amount, and a steering operation amount. During the automated-driving mode, the vehicle control device 21 outputs an instruction value for executing automated-driving.

The driving switching unit 30 switches the operation mode between an automated-driving mode in which automated-driving is performed and a manual-driving mode in which manual-driving is performed. In other words, the driving switching unit 30 switches the authority to drive the subject vehicle between the vehicle control device 21 and the driver. When the vehicle control device 21 is given the authority to drive the subject vehicle, the driving switching unit 30 transmits an instruction value output from the vehicle control device 21 to the travel control ECU 31. The driving switching unit 30 transmits the operation amount by the driver to the travel control ECU 31 when the driver is authorized to operate the subject vehicle.

The driving switching unit 30 switches the operation mode between the automated-driving mode and the manual-driving mode according to a mode switching request. There are two types of mode switching requests: a manual-driving mode switching request for changing the operation mode from the automated-driving mode to the manual-driving mode; and an automated-driving mode switching request for changing the operation mode from the manual-driving mode to the automated-driving mode. The driving switching request is generated, for example, by a driver's switch operation and input to the driving switching unit 30. Also, the mode switching request is generated, for example, by a judgment of the vehicle control unit 21 and is input to the driving switching unit 30. The driving switching unit 30 switches the operation mode according to the mode switching request.

The travel control ECU 31 is a travel control unit, and is an electronic control unit that controls travelling of the subject vehicle. The traveling control includes acceleration/deceleration control and/or steering control. The travel control ECU 31 includes a steering ECU that performs steering control, a power unit control ECU and a brake ECU that perform acceleration/deceleration control, and the like. The travel control ECU 31 is configured to perform the traveling control by outputting control signals to traveling control devices such as an electronic throttle, a brake actuator, and an EPS (Electric Power Steering) motor.

The vehicle control unit 21 includes, for example, a processor, a memory, an I/O, and a bus that connects those devices, and executes various processes related to the automated-driving by executing a control program stored on the memory. Executing a process related to automated-driving means executing a vehicle control method for automatically controlling traveling of the subject vehicle 40. The memory referred to here is a non-transitory tangible storage medium for storing programs and data that can be read by a computer non-transitory way. The non-transitory tangible storage medium is embodied by a semiconductor memory or a magnetic disk.

Subsequently, the schematic configuration of the vehicle control unit 21 will be described with reference to FIG. 1. As shown in FIG. 1, the vehicle control unit 21 includes, as functional blocks, a vehicle position acquisition unit 19, a sensing information acquisition unit 22, a map data acquisition unit 23, a communication information acquisition unit 24, a driving environment acquisition unit 25, and an automated-driving unit 26. Some or all of the functions executed by the vehicle control unit 21 may be formed as hardware with one or more ICs or the like. A part or all of the functional blocks included in the vehicle control unit 21 may be realized by executing software by a processor and a combination of hardware members. This vehicle control unit 21 corresponds to an in-vehicle device.

The vehicle position acquisition unit 19 acquires a vehicle position of the subject vehicle that is sequentially positioned by the locator 33. The sensing information acquisition unit 22 acquires sensing information, which is the result of detection performed by the surroundings monitoring sensor 35. The sensing information acquisition unit 22 also acquires vehicle state information, which is the result of detection performed by the vehicle state sensor 38.

The map data acquisition unit 23 acquires map data stored in the map database 34. The map data acquisition unit 23 may acquire map data of surroundings of the subject vehicle according to the vehicle position of the subject vehicle acquired by the subject vehicle position acquisition unit 19. The map data acquisition unit 23 preferably acquires map data in a range wider than the detection range of the surroundings monitoring sensor 35.

The communication information acquisition unit 24 acquires information about surrounding vehicles around the subject vehicle using the communication module 37. The information about the surrounding vehicles includes, for example, identification information, speed information, acceleration information, yaw rate information, position information, etc. of the surrounding vehicles. Identification information is information for identifying each vehicle. The identification information may include, for example, classification information indicating a predetermined classification such as a vehicle type and a vehicle class to which the vehicle corresponds.

The driving environment acquisition unit 25 acquires a driving environment of the subject vehicle and generates a virtual space simulating the driving environment acquired by the automated-driving unit 26. Specifically, the driving environment acquisition unit 25 recognizes the driving environment of the subject vehicle based on a vehicle position of the subject vehicle acquired by the vehicle position acquisition unit 19, sensing information and vehicle state information acquired by the sensing information acquisition unit 22, map data acquired by the map data acquisition unit 23, the driving environment of the subject vehicle acquired by the communication information acquisition unit 24, and the like. As an example, the driving environment acquisition unit 25 uses such information to recognize the positions, shapes, travelling states, etc. of objects around the subject vehicle, and the positions of road markings around the subject vehicle, and then generates a virtual space where the actual driving environment is reproduced.

The driving environment acquisition unit 25 also recognizes, from the sensing information acquired by the sensing information acquisition unit 22, a distance between the subject vehicle and the surrounding object, the relative speed of the surrounding object with respect to the subject vehicle, the shape and size of the surrounding object, etc., as the driving environment. In addition, when the communication information acquisition unit 24 is able to acquire information on surrounding vehicles, the driving environment acquisition unit 25 may be configured to recognize the driving environment using the information on the surrounding vehicles. For example, the position, speed, acceleration, yaw rate, etc. of the surrounding vehicle may be recognized from information such as the position, speed, acceleration, yaw rate, etc. of the surrounding vehicle. Also, performance information such as a maximum deceleration and a maximum acceleration of the surrounding vehicle may be recognized from identification information of the surrounding vehicle. As one example, a correspondence relationship between the identification information and the performance information may be stored in advance in a non-volatile memory of the vehicle control device 21, and the performance information may be recognized from the identification information by referring to the stored relationship. Note that the aforementioned classification information may be used as the identification information.

It is preferable that the driving environment acquisition unit 25 may distinguish whether the surrounding object detected by the surroundings monitoring sensor 35 is a moving object or a stationary object. Moreover, it is preferable that the driving environment recognizing unit distinguishes and recognizes the type of surrounding object. The type of surrounding object can be distinguished and recognized by, for example, performing pattern matching on an image captured by a surrounding monitoring camera. As for types, for example, a structure such as a guardrail, an object falling on the road, a pedestrian, a bicycle, a motorcycle, an automobile, or the like may be distinguished and recognized. If the surrounding object is an automobile, the type of the surrounding object may be a vehicle class, a vehicle type, or the like. Whether the surrounding object is a moving object or a stationary object can be recognized according to the type of the surrounding object. For example, when the type of the surrounding object is a structure or an object falling on the road, the surrounding object may be recognized as a stationary object. When the type of the surrounding object is a pedestrian, a bicycle, a motorcycle, or an automobile, the surrounding object may be recognized as a moving object. An object that is unlikely to move immediately, such as a parked vehicle, may be recognized as a stationary object. A parked vehicle may be recognized when the vehicle is stopped and its brake lamp is not on by image recognition.

The automated-driving unit 26 performs processing related to substitution of driving operation by the driver. As shown in FIG. 1, the automated-driving unit 26 includes a path generation unit 27, a path checking unit 28, and an automated-driving function unit 29 as sub-functional blocks. In order to improve the performance in automated-driving, the automated-driving unit 26 is designed considering avoidance of unreasonable risks and positive risk balance.

The path generation unit 27 uses the driving environment acquired by the driving environment acquisition unit 25 to generate a driving plan for driving the subject vehicle by automated-driving. The driving environment here may be a traffic scenario (hereinafter, simply referred to as a scenario) itself, or a scenario may be selected in the process of using the driving environment in generating a driving plan. For example, a route search process is performed to generate a recommended route, as a med-to-long term driving plan, from the current position of the subject vehicle to the destination. In addition, as a short-term driving plan for driving in accordance with the med-to-long-term driving plan, a driving plan for changing lanes, a driving plan for driving in the center of the lane, a driving plan for following the preceding vehicle, an obstacle avoidance driving plan, and the like are generated. These driving plans can be a plan for keeping the subject vehicle 40 travelling. A plan for extremely short-term travel to bring the subject vehicle 40 to an emergency stop may need not be included in the driving plan here. Generation of a driving plan here may correspond to at least one of route planning (or path planning), tactical behavior planning, and trajectory planning.

The path generation unit 27 may generate, as a driving plan, a route that is a certain distance from, or in the center of, the recognized lane line, or a route that follows the recognized behavior of the preceding vehicle or the travel trajectory of the preceding vehicle. Further, the path generation unit 27 may generate, as a driving plan, a route for changing lanes of the subject vehicle to a vacant area in an adjacent lane extending in the same traveling direction. The path generation unit 27 may generate, as a driving plan, a route for avoiding obstacles and maintaining travel or a deceleration plan for stopping prior to an obstacle. The obstacles here may be other road users. The other road users may include other vulnerable road users (e.g., pedestrians), other non-vulnerable road users (e.g., surrounding vehicles). The obstacles may also be considered as safety-related objects. The path generation unit 27 may generate a driving plan determined to be optimal by machine learning or the like. The path generation unit 27 calculates, for example, one or more routes as a short-term driving plan. For example, the path generation unit 27 may include, in the short-term driving plan, acceleration/deceleration information for speed adjustment on the calculated route.

As an example, when a front obstacle recognized by the driving environment acquisition unit 25 is a travel interfering obstacle that interferes with traveling of the subject vehicle, the path generation unit 27 may generate a driving plan according to the situation while evaluating the validity by the path checking unit 28 as described later. In the following, the description will be made with an example where the travel interfering obstacle is recognized and specified. Note that the travel interfering obstacle may be a fallen object on the road, a parked vehicle, or a preceding vehicle in the travel lane of the subject vehicle. A preceding vehicle corresponding to the travel interfering obstacle may be a preceding vehicle which is travelling with average vehicle speed significantly lower than the regulation speed of the traveling road, even though the road is not congested. It should be noted that since slow driving is often required in a narrow road, it is preferable not to recognize preceding vehicles as an travel interfering obstacle in such narrow roads. In the following, when the driving path of the subject vehicle corresponds to a two-way road without a center line, moving objects such as preceding vehicles are not identified as obstacles, but stationary objects such as parked vehicles are identified as obstacles.

For example, when the driving environment acquisition unit 25 recognizes and identifies a travel interfering obstacle, the path generation unit 27 performs processing according to the travel route of the subject vehicle. For example, when the traveling road of the subject vehicle is a two-way road without a center line, the path generation unit 27 determines whether the subject vehicle can travel within the travel lines while securing a lateral distance with a threshold value or more between the travel interfering obstacle and the subject vehicle The threshold value may be a lower limit value that is set as a safety distance, as will be described later. The lower limit value may be, for example, a value of the safety distance that is set when the subject vehicle travels while keeping the vehicle speed as low as possible. In other words, the path generation unit 27 determines whether the subject vehicle can travel within the travel lane while securing the safety distance in the lateral direction between the subject vehicle and the travel interfering obstacle. The threshold value may be a predetermined fixed value, or if the travel interfering obstacle is a moving object, the threshold value may be a value that changes according to the behavior of the moving object.

As an example, the path generation unit 27 determines that the subject vehicle can travel within the travel lane while securing the safety distance in the lateral direction between the subject vehicle and the travel interfering obstacle when the width of the travel lane is partially blocked by the travel interfering obstacle and the non-blocked portion of the travel lane is greater than the sum of the vehicle width of the subject vehicle and the above-described threshold value. If the subject vehicle is determined to travel within the travel lane while securing the safety distance between the subject vehicle and the travel interfering obstacle, the path generation unit 27 may generate a driving plan where the subject vehicle travels along the travel lane while passing through the side of the travel interfering obstacle and avoiding an oncoming vehicle.

On the contrary, the path generation unit 27 determines that the subject vehicle cannot travel within the travel lane while securing the safety distance in the lateral direction between the subject vehicle and the travel interfering obstacle when the non-blocked portion of the travel lane is equal to or less than the sum of the vehicle width of the subject vehicle and the above-described threshold value. As for the value of the vehicle width of the subject vehicle, a value stored in advance in the non-volatile memory of the vehicle control device 21 may be used. The lane width of the travel lane may be specified from map data acquired by the map data acquisition unit 23. If the subject vehicle is determined not to travel within the travel lane while securing the safety distance between the subject vehicle and the travel interfering obstacle, the path generation unit 27 may generate a driving plan where the subject vehicle stops. This is because when the subject vehicle is traveling on a two-way road with no center line and when the subject vehicle is determined not to travel within the travel lane while securing the safety distance in the lateral direction between the subject vehicle and the travel interfering obstacle, it is not possible for the subject vehicle to travel. In this case, for example, the vehicle control device 21 may switch from automated-driving to manual-driving. In addition, when switching from automated-driving to manual-driving, switching to manual-driving may be performed after an advance notification of requesting for switching of driving is sent.

When the traveling road of the subject vehicle is a road with a plurality of lanes each way, the path generation unit 27 may generate a driving plan where the subject vehicle will make lane change to an adjacent lane in the same direction as the current lane of the subject vehicle. When the traveling road of the subject vehicle is a road with one-lane each way, the path generation unit 27 determines whether the subject vehicle can travel within the travel lines while securing a lateral distance with a threshold value or more between the travel interfering obstacle and the subject vehicle, as described above. If the subject vehicle is determined to travel within the travel lane while securing the safety distance between the subject vehicle and the travel interfering obstacle, the path generation unit 27 may generate a driving plan where the subject vehicle travels along the travel lane while passing through the side of the travel interfering obstacle. If the travelling road of the subject vehicle is a road with one-lane each way and the subject vehicle is determined not to travel within the travel lane while securing the safety distance between the subject vehicle and the travel interfering obstacle, the path generation unit 27 may generate a driving plan where the subject vehicle crosses over the travel lane while passing through a side of the travel interfering obstacle and avoiding an oncoming vehicle.

the path checking unit 28 evaluates the driving plan generated by the path generation unit 27. The driving plan can also be referred to as a travel route. Evaluating a driving plan means executing a route verification method for validating the travel route. In order to facilitate the evaluation of the driving plan, the path checking unit 28 may evaluate the driving plan using a mathematical formula model that formulates the concept of safety driving. The path checking unit 28 may evaluate the driving plan by judging whether an inter-object distance, which is an inter-object distance between the subject vehicle and a surrounding object, is equal to or greater than a safety distance which is calculated by a predetermined mathematical formula model and which serves as a reference for evaluating the inter-object relationship. For example, the inter-object distance may be a distance in the longitudinal direction and the lateral direction of the subject vehicle.

The mathematical formula model does not assure that an accident will not occur at all but assures that when a vehicle distance falls below the safety distance, the subject vehicle will take an appropriate action for avoiding collision. The appropriate action may be a proper response. The proper response may be a set of corrective actions that the driving policy (DP) might require to maintain the SOTIF (safety of the intended functionality) The proper response may be an action that resolves a critical situation when another road user behaves according to a reasonably foreseeable assumption. As an example of the proper response, shifting to a minimum risk condition may be performed. An example of the appropriate action for collision avoidance as mentioned herein is braking with a reasonable force. Braking with a reasonable force includes, for example, braking at a maximum deceleration available for the subject vehicle. The safety distance calculated by the mathematical formula model can be rephrased as a minimum distance that the subject vehicle should keep between the subject vehicle and an obstacle in order to avoid closely reaching the obstacle.

The automated-driving function unit 29 causes the driving control ECU 31 to automatically accelerate, decelerate, and/or steer the subject vehicle according to the driving plan output from the path checking unit 28. That is, the automated-driving function unit 29 causes the ECU 31 to drive the subject vehicle on behalf of the driver, in other words, perform automated-driving. The automated-driving function unit 29 performs automated-driving according to the driving plan evaluated by the path checking unit 28 as usable for automated-driving. If the driving plan is to travel along a route, automated-driving along this route may be performed. If the driving plan is to stop or decelerate, the subject vehicle is automatically stopped or decelerated. The automated-driving function unit 29 performs automated-driving according to the driving plan output from the path checking unit 28 so that the subject vehicle automatically travels while avoiding closely reaching a surrounding object.

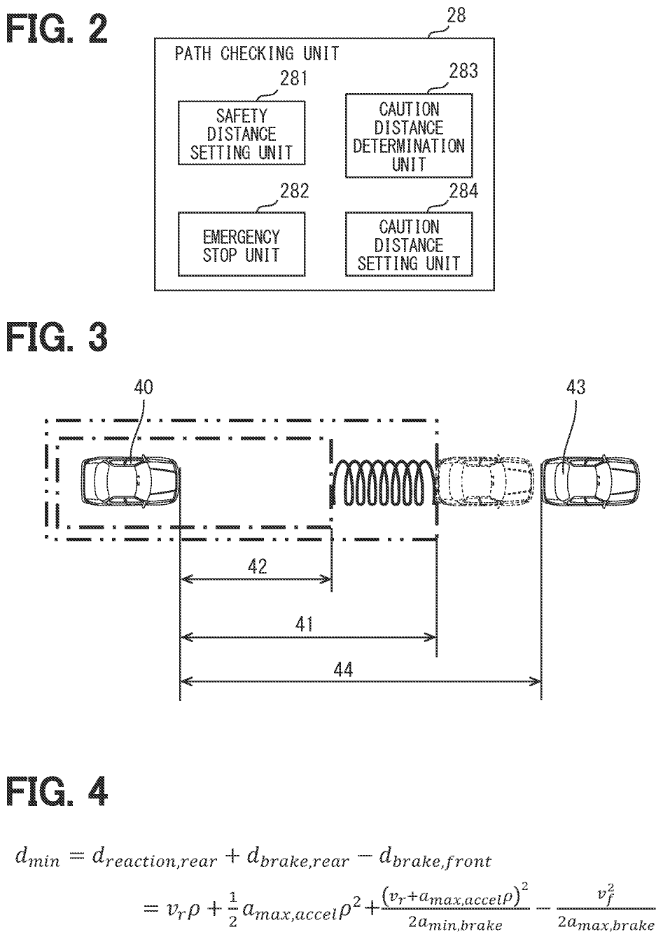

Next, the path checking unit 28 will be described in further detail. As shown in FIG. 2, the path checking unit 28 includes a safety distance setting unit 281, a caution distance setting unit 284, a caution distance determination unit 283, and an emergency stop unit 282 as sub-functional blocks. The safety distance setting unit 281 calculates the safety distance using the mathematical formula model described above and sets the calculated safety distance as the safety distance 42. The safety distance setting unit 281 calculates and sets the safety distance 42 using at least information of behaviors of the vehicle. The safety distance setting unit 281 may use, for example, an RSS (Responsibility Sensitive Safety) model as a mathematical formula model. Here, the mathematical formula model may be a safety-related model itself, or may be a part of the safety-related model.

The safety distance setting unit 281 sets a minimum safety distance 42 that should be kept between the subject vehicle 40 and an obstacle in order to avoid closely approaching the obstacle. The safety distance setting unit 281 sets, for example, the safety distance 42 in a forward direction and left and right directions of the subject vehicle 40. For example, the safety distance setting unit 281 calculates, based on the information on the behaviors of the subject vehicle 40, a shortest distance in front of the subject vehicle 40 with which the subject vehicle 40 can stop as the safety distance 42, as shown in FIG. 3. As a specific example, the safety distance setting unit 281 may calculate, based on the speed, maximum acceleration, maximum deceleration, and response time of the subject vehicle 40, a distance, as the front safety distance 42, within which the subject vehicle can stop after the subject vehicle 40 traveled with the maximum acceleration from the current vehicle speed for the response time and then decelerated with the maximum deceleration. Here, the speed, maximum acceleration, and maximum deceleration of the subject vehicle 40 are those in the longitudinal direction of the subject vehicle 40. Also, the response time may be a time from an instruction for operating the braking device to the start of the operation when the subject vehicle 40 is stopped by automated-driving. As an example, the maximum acceleration, maximum deceleration, and response time of the subject vehicle 40 may be stored in advance in the non-volatile memory of the vehicle control device 21. Even when the safety distance setting unit 281 does not recognize a moving object but recognizes a stationary object in front of the subject vehicle, the safety distance setting unit 281 may set the front safety distance as a reference.

When the safety distance setting unit 281 recognizes a moving object in front of the subject vehicle, the safety distance setting unit 281 may calculate, based on the information on the behaviors of the subject vehicle 40 and the front moving object, a distance, within which the subject vehicle can stop without colliding with the moving object, as the front safety distance 42. In the following description, the moving object is assumed as an automobile vehicle. The moving object includes a preceding vehicle, an oncoming vehicle, and the like. As a specific example, when the moving directions of the subject vehicle 40 and the front moving object are opposite to each other, the safety distance setting unit 281 may calculate, based on the speeds, maximum accelerations, maximum decelerations, and response times of the subject vehicle 40 and the front moving object, a distance, as the front safety distance 42, within which the subject vehicle 40 and the front moving object can stop without colliding with each other after the subject vehicle 40 and the front moving object traveled with the maximum accelerations from the current speeds for the response times and then decelerated with the maximum decelerations. On the contrary, when the moving directions of the subject vehicle 40 and the front moving object are the same, the safety distance setting unit 281 may calculate a distance, as the front safety distance 42, within which the subject vehicle 40 and the front moving object can stop without colliding with each other after the front moving object decelerated with the maximum deceleration from the current speed and the subject vehicle 40 traveled with the maximum acceleration for the response time and then decelerated with the maximum deceleration.

If the speed, maximum acceleration, maximum deceleration, and response time of the moving object can be acquired by the communication information acquisition unit 24, the information acquired by the communication information acquisition unit 24 may be used by the safety distance setting unit 281. As for the information that can be recognized by the driving environment acquisition unit 25, the information recognized by the driving environment acquisition unit 25 may be used. In addition, values of the maximum acceleration, maximum deceleration, and response time of a general, typical vehicle may be stored in advance on the non-volatile memory of the vehicle control unit 21, and the values of the general vehicle may be used, as the maximum acceleration, maximum deceleration, and response time of the moving object, by the safety distance setting unit 281. That is, a minimal set of reasonably foreseeable assumptions about behaviors of the moving object may be defined depending on a kinematic characteristics of the moving object and the scenario.

When the safety distance setting unit 281 recognizes a moving object behind the subject vehicle 40, the safety distance setting unit 281 may calculate, based on information on behaviors of the subject vehicle 40 and the rear moving object, a distance, within which the subject vehicle can stop without colliding with the rear moving object, as the backward safety distance 42. The rear moving object may include a following vehicle travelling in the same lane of the subject vehicle 40 and a following vehicle travelling in an adjacent lane of the subject vehicle 40. The safety distance setting unit 281 may set the backward safety distance 42 for the subject vehicle 40 by estimating the safety distance 42 for the rear moving body in the same manner as calculating the front safety distance 42.

As shown in FIG. 6, the safety distance setting unit 281 sets, based on the behavior information of the subject vehicle 40, a distance in a lateral direction, as the safety distance 42, for which the subject vehicle 40 travels in the lateral direction until the speed of the subject vehicle 40 in the lateral direction decreases to zero for a shortest time. For example, the safety distance setting unit 281 may calculate, based on the speed, maximum acceleration, maximum deceleration, and response time of the subject vehicle 40 in the lateral direction, a distance for which the subject vehicle 40 would travel in the lateral direction during a time period after the subject vehicle 40 traveled with the maximum acceleration from the current speed in the lateral direction for the response time and then decelerated with the maximum deceleration until the speed of the subject vehicle in the lateral direction decreases to zero. Also, the response time may be a time from an instruction for operating the steering device to the start of the operation when the subject vehicle 40 is controlled by automated-driving. Even when the safety distance setting unit 281 does not recognize a moving object in the lateral direction but recognizes a stationary object on a side of the subject vehicle, the safety distance setting unit 281 may set the lateral safety distance 42 as a reference.

When the safety distance setting unit 281 recognizes a moving object in the lateral direction of the subject vehicle 40, the safety distance setting unit 281 may calculate, based on the information on behaviors of the subject vehicle 40 and the moving object, a distance in the lateral direction, for which the subject vehicle 40 and the moving object would travel in the lateral direction for a time period during which the speeds of the subject vehicle 40 and the moving object in the lateral direction decrease to zero without colliding with each other, as the lateral safety distance 42. As a specific example, the safety distance setting unit 281 may calculate, based on the speeds, maximum accelerations, maximum decelerations, and response times of the subject vehicle 40 and the moving object, a distance, as the lateral safety distance 42, within which the subject vehicle 40 and the moving object can stop without colliding with each other after the subject vehicle 40 and the moving object traveled in the lateral direction with the maximum accelerations from the current speeds for the response times and then decelerated with the maximum decelerations. Values of the maximum acceleration, maximum deceleration, and response time of an obstacle for calculating at least one of the safety distance 42 and a safety envelope (as detailed below) may be set according to an upper limit or a lower limit each of which is defined in a minimal set of assumptions that are reasonably foreseeable considered in a scenario.

The caution distance setting unit 284 sets a caution distance 41 that is greater than the safety distance 42 as a distance to be kept between the subject vehicle 40 and a surrounding vehicle 43 which is an obstacle traveling around the subject vehicle 40. The caution distance 41 includes the safety distance 42 therein and serves as a distance for preventing easily shifting to an emergency avoidance mode. The emergency avoidance mode is a control mode to perform a stop plan for suddenly decelerating and stopping the subject vehicle for safety. The surrounding vehicle 43 is another vehicle that travels around the subject vehicle 40. For example, a preceding vehicle travelling in front of the subject vehicle 40, a following vehicle travelling behind the subject vehicle 40, and a vehicle traveling an adjacent lane of the subject vehicle 40 may be included.

The safety distance 42 is calculated using the speed and acceleration of a preceding vehicle as described above, but if the acceleration/deceleration of the preceding vehicle is irregularly performed, the calculated results of the safety distance 42 may be unstable. In view of this, the caution distance 41 is introduced, and a driving plan where the vehicle-to-vehicle distance 44 is equal to or greater than the caution distance 41 is used as much as possible. If the vehicle-to-vehicle distance decreases to be smaller than the caution distance 41 due to sudden deceleration of the preceding vehicle, a driving plan is selected to expand the vehicle-to-vehicle distance 44 to be equal to or greater than the caution distance 41. Therefore, the caution distance 41 has a cushioning function as a virtual coil spring illustrated in in FIG. 3.

Here, irregular acceleration/deceleration by a preceding vehicle may be one example that the current behavior of the preceding vehicle is not a reasonably foreseeable behavior. The current behavior here is calculated from the behavior that is performed during a predetermined time period prior to a timing the behavior is detected, for example. The determination result as to whether the current behavior of a preceding vehicle is reasonably foreseeable may be stored in a storage medium or a storage device mounted in the subject vehicle 40 for an ex-post-facto verification or an ex-post-facto validity confirmation. Setting the caution distance 41 may be an example of setting a stabilization condition to reduce a time instability of the safety envelope. Setting the stabilization condition may be performed by updating the conditions or by adding an additional condition to the existing conditions. Furthermore, the setting status of the condition may be stored in a storage medium or a storage device mounted in the subject vehicle 40 for an ex-post-facto verification or an ex-post-facto validity confirmation. The storage medium may be a non-volatile memory of the vehicle control device 21, for example.

The caution distance setting unit 284 sets, for example, the caution distance 41 in a front direction and left and right directions of the subject vehicle 40. As shown in FIG. 3, when the surrounding vehicle 43 is a preceding vehicle, the caution distance setting unit 284 calculates, from the information on the behavior of the preceding vehicle, a distance, as the caution distance 41, within which the vehicle-to-vehicle distance 44 can be secured by performing slow deceleration. The slow deceleration is a deceleration that does not make the passenger feel uncomfortable, and this deceleration has been determined in advance through experiments or the like. The slow deceleration can also be a deceleration that does not cause the seat belt to be rocked. The distance within which the vehicle-to-vehicle distance 44 can be secured means that the vehicle-to-vehicle distance 44 with which an emergency stop mode would not be executed due to a predicted decrease in the safety distance 42 by this slow deceleration.

As a specific example, when the speed of a preceding vehicle is unstable and there is an unnatural speed difference Δv, a variation distance due to the speed difference Δv is calculated as an offset distance Δd, and the caution distance 42 is calculated by adding the offset distance Δd to the safety distance 42. The fact that the speed of a preceding vehicle is unstable and that there is an unnatural speed difference Δ may be one example that the current behavior of the preceding vehicle is not reasonably foreseeable. The speed difference Δv is a difference between the maximum speed and the minimum speed of the preceding vehicle during a predetermined unit observation time. The unit observation time is a time for determining that the speed of the preceding vehicle is unstable, in other words, that the preceding vehicle travels in an erratic manner. Therefore, it is preferably that the unit observation time is less than 1 minute at the longest, and may be 10 seconds or less. The distance obtained by multiplying the speed difference Δv by the offset time is the offset distance Δd. The caution distance 41 is, as described above, a distance that serves as a buffer for the safety distance 42. The offset distance Δd to be added to the safety distance 42 is preferably shorter than the safety distance 42 itself because the caution distance 41 acts like a buffer. The offset time is set so that the offset distance Δd is shorter than the safety distance 42.

Furthermore, the distance can be calculated as the caution distance 41 by deleting the term relating to the braking distance of the preceding vehicle from the RSS model for calculating the safety distance 42. Here, the caution distance 41 may be one aspect of the safety distance 42, i.e., an extended version of the safety distance 42. Furthermore, the safety envelope may be defined as a concept corresponding to at least one of the safety distance 42 and the caution distance 41 or as a general concept collectively including the safety distance 42 and the caution distance 41. The definition of a “safety envelope” may be a common concept that can be used to address all the principles that the driving policy might comply with. According to this concept, the autonomous vehicle (AV) might have one or more boundaries around the vehicle, where the violation of one or more of these boundaries result in different responses by the AV. The safety envelope may be a set of limits and conditions under which the system is designed to maneuver, subject to controls to maintain maneuvering at an acceptable level of risk.

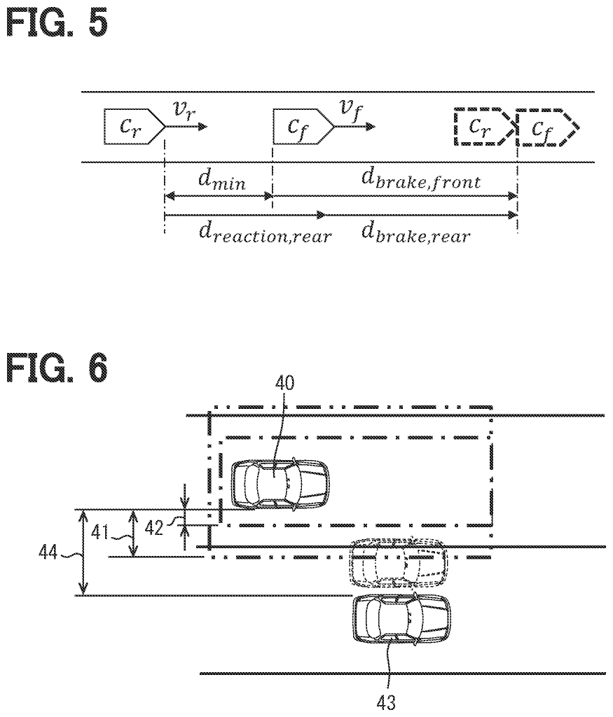

FIG. 4 shows an RSS model in which the distance of the preceding vehicle is not deleted. FIG. 4 shows a formula for calculating the safety distance 42 when a rear-end collision is determined. In FIG. 4, the safety distance 42 is indicated as dₘᵢₙ. The meaning of the middle side in FIG. 4 will be explained with reference to FIG. 5. FIG. 5 shows a relationship between the safety distance dₘᵢₙ in a situation where a rear-end collision is determined, a stopping distance d_{brake,front} of the vehicle c_{f} as a preceding vehicle, an idle running distance dr_{eaction,rear} of the vehicle cᵣ as a following vehicle, and a braking distance d_{brake,rear} of the vehicle cᵣ. This is expressed by an equation as shown in the relationship of FIG. 4 between the left side and the middle side.

Assuming that the vehicle c_{f} has a speed of at the start timing of deceleration and constant deceleration aₘₐₓ, break until the vehicle c_{f} stops, the third term on the middle side can be converted to the fourth term on the right side. Assuming that the vehicle cᵣ is traveling at the speed vᵣ and then is accelerated at the maximum acceleration a_{max,accel} during the reaction time ρ, the first term on the middle side can be converted to the first and second terms on the right side. When the vehicle cᵣ decelerates at a constant deceleration aₘᵢₙ, break until the vehicle cᵣ stops after it starts decelerating, the second term on the middle side can be converted to the third term on the right side. From the above, the right side is obtained. The term relating to the braking distance of the preceding vehicle is the fourth term on the right side.

As shown in FIG. 6, when the surrounding vehicle 43 is a vehicle on the left or right side of the subject vehicle 40, the caution distance setting unit 284 calculates, based on the information on behaviors of the surrounding vehicle 43, a distance, as the caution distance 41, within which the subject vehicle 40 can secure the vehicle-to-vehicle distance 44 with soft steering. The soft steering is steering which generates the approximately same lateral acceleration as the lateral acceleration that is generated when a passenger normally operates the steering wheel. This lateral deceleration has been set in advance through experiment or the like. Furthermore, soft steering can be steering in which the seat belt is not locked. The distance within which the vehicle-to-vehicle distance 44 can be secured means that the vehicle-to-vehicle distance 44 with which an emergency stop mode would not be executed due to a predicted decrease in the safety distance 42 by this soft steering.

Further, the caution distance setting unit 284 sets the caution distance 41 when the subject vehicle 40 travels in a non-normal traveling place such as a parking lot. Each vehicle running in a parking lot travels with the caution distance 41 set for the vehicle. Then, each vehicle selects a driving plan so that the caution distances 41 do not overlap with each other. When traveling in a parking lot, the caution distance 41 is set according to a vehicle class rather than a vehicle speed. If the caution distances 41 overlap with each other, a driving plan to eliminate the overlap of the caution distances 41 by setting the vehicle-to-vehicle distance 44 greater than or equal to the caution distance 41. In a parking lot, for example, when the caution distance 41 for a surrounding vehicle 43 traveling in an opposite direction and the caution distance 41 for the subject vehicle 40 overlap with each other, if the overlap can be eliminated by moving the subject vehicle forward, the overlap is eliminated by prioritizing moving forward over moving backward.

The caution distance setting unit 284 sets the caution distance 41 based on a vehicle class of the subject vehicle 40 when traveling in a parking lot. The caution distance 41 for the surrounding vehicle 43 may be calculated by the subject vehicle 40 from the vehicle class of the surrounding vehicle 43, or may be acquired via inter-vehicle communication.

Whether to set such a caution distance 41 is determined by the caution distance determination unit 283. Therefore, the caution distance 41 is always calculated by the caution distance setting unit 284 regardless of whether it is actually set. The caution distance determination unit 283 determines whether to set the caution distance 41 for the surrounding vehicle 43. The caution distance determination unit 283 determines whether to set the caution distance 41 for the surrounding vehicle 43 when the safety distance 42 temporarily increases or when the safety distance 42 will increase in future. The caution distance 41 may always be set for the surrounding vehicle 43, but in this embodiment, the caution distance 41 is set only when a predetermined setting condition is satisfied. For example, when the safety distance 42 for the surrounding vehicle 43 temporarily increases, specifically when the traveling state of the surrounding vehicle 43 is not stable, or when there is a large curve ahead, the caution distance determination unit 283 determines to set the caution distance 41. Further, for example, when the safety distance 42 for the surrounding vehicle 43 will increase in future, specifically, when the road surface condition ahead badly changes, the caution distance determination unit 283 determines to set the caution distance 41. Therefore, when the condition that time change in the calculated safety distance 42 will likely increase is met and when the safety distance 42 likely has a maximum value which increases by a constant value or a constant ratio from the average value of the safety distance 42 for a predetermined elapsed time, the caution distance determination unit 283 determines to set the caution distance 41.

When the caution distance 41 is set for the surrounding vehicle 43, the setting may be repeatedly, continuously performed as long as the surrounding vehicle 43 exists in the surroundings, but if a predetermined termination condition is met, the setting of the caution distance 41 may be terminated. In the present embodiment, when the caution distance determination unit 283 determines that a driving validity of the subject vehicle 40 is ensured after the caution distance 41 was already set for the surrounding vehicle 43, the caution distance determination unit 283 determines to terminate setting the caution distance 41 for the surrounding vehicle 41.

For example, when the vehicle-to-vehicle distance 44 for a preceding vehicle is less than or equal to the safety distance 42, or when the safety distance 42 is likely to be violated and the calculation results of the safety distance 42 are unstable and drastically vary, the caution distance determination unit 283 sets the caution distance 41 for the preceding vehicle. This means that the caution distance 41 is set when the preceding vehicle as the surrounding vehicle 43 is determined to travel in an erratic manner. This contributes to stable travelling of the subject vehicle 40. After the caution distance 41 was set because a preceding vehicle was determined to be unstable, if the safety distance 42 and the vehicle-to-vehicle distance 44 with respect to the preceding vehicle are stabilized, the caution distance determination unit 283 terminates setting the caution distance 41 for the preceding vehicle.

Further, for example, when there is a large curve in front of the preceding vehicle and the subject vehicle is determined to be not able to stop safely by the emergency avoidance mode, the caution distance determination unit 283 sets the caution distance 41 for the preceding vehicle. Then, when the vehicle has passed the curve, the caution distance determining section 283 terminates setting the caution distance 41 for the preceding vehicle.

Furthermore, for example, when it is determined that the vehicle-to-vehicle distance 44 should be expanded in advance because there is a cause for expanding the braking distance in front of the preceding vehicle, the caution distance determination unit 283 sets the caution distance 41 for the preceding vehicle. Then, after the cause has been already introduced in calculation of the safety distance 42, the caution distance determination unit 283 terminates setting the caution distance 41 for the preceding vehicle.

Further, for example, when the safety distance 42 is extended and the vehicle-to-vehicle distance 44 is shortened, more specifically when the subject vehicle 40 is accelerating because the front space is open, the caution distance determination unit 283 may set the caution distance 41 for the preceding vehicle. Then, after the safety distance 42 and the caution distance 44 for the preceding vehicle are stabilized, the caution distance determination unit 283 terminates setting the caution distance 41 for the preceding vehicle.

Furthermore, if calculation of the safety distance 42 for a vehicle (a right/left side vehicle) traveling in an adjacent lane on a right or left side of the subject vehicle is not stabilized and significantly varies, the caution distance determination unit 283 sets the caution distance 41 for the right/left side vehicle traveling on a right or left side of the subject vehicle. Then, after the safety distance 42 and the vehicle-to-vehicle distance 44 are stabilized, the caution distance determination unit 283 terminates setting the caution distance 41 for the right/left side vehicle traveling on a right or left side of the subject vehicle.

Further, for example, when the right/left side vehicle is not stably traveling along the center line of the lane and meandering, the caution distance determination unit 283 sets the caution distance 41 for the right/left side vehicle. Thereafter, when it is determined that the right/left side vehicle is travelling stably, the caution distance determination unit 283 terminates setting the caution distance 41 for the right/left side vehicle.

Furthermore, for example, when there is a large curve ahead and the right/left side vehicle is not traveling stably on the curve, the caution distance determination unit 283 sets the caution distance 41 for the right/left side vehicle. Then, when the vehicle has passed the curve, the caution distance determining section 283 terminates setting the caution distance 41 for the right/left side vehicle.

Further, for example, when the right/left side vehicle deviate from the center of the lane to avoid something, the caution distance determination unit 283 sets the caution distance 41 for the right/left side vehicle. Then, when the right/left side vehicle ends the deviation, the caution distance determining section 283 terminates setting the caution distance 41 for the right/left side vehicle.

Further, for example, when the subject vehicle 40 is traveling in a parking lot, the caution distance determination unit 283 sets the caution distance 41. Then, when the vehicle terminates traveling in the parking lot, the caution distance determination unit 283 terminates setting the caution distance 41.

The caution distance 41 may be set to 0 at the time of terminating the setting of the caution distance 41, or the caution distance 41 may be gradually decreased and then set to 0. Further, when the caution distance 41 is determined to be set again when the caution distance 41 is gradually decreased, the caution distance 41 is set again.

The emergency stop unit 282 is an example of an emergency control unit. The emergency stop unit 282 selects a driving plan for the automated-driving function unit 29 from the driving plans generated by the path generation unit 27. The driving plan selected must be a cautious plan or a semi-cautious plan. The cautious plan is a driving plan that secures the safety distance 42 with respect to target vehicle. The semi-cautious plan is a driving plan that secures the caution distance 41 with respect to the target vehicle.

Further, the emergency stop unit 282 selects a parking plan from the driving plans generated by the path generation unit 27 when the subject vehicle is traveling in a non-normal travelling location such as a parking lot. The parking plan is a driving plan in which the caution distance 41 is set for both the subject vehicle 40 and the surrounding vehicles 43. The parking plan is a driving plan such that the caution distances 41 of the subject vehicle 40 and the surrounding vehicles 43 do not overlap with each other, and is a driving plan that gradually eliminates the overlap even if they are overlapped with each other.

The emergency stop unit 282 provides the automated-driving function unit 29 with a predetermined emergency stop plan. The emergency stop plan is a driving plan that should be selected in the absence of the cautious plan. The emergency stop plan provides, for example, a route for decelerating the subject vehicle 40 at the maximum deceleration until the subject vehicle 40 stops without changing the steering angle.

The emergency stop unit 282 determines repeatedly whether the subject vehicle is traveling while ensuring the safety distance 42 set by the safety distance setting unit 281. Then, the emergency stop unit 282 controls the subject vehicle 40 to make an emergency stop when the safety distance 42 cannot be secured during traveling.

The emergency stop unit 282 provides the automated-driving function unit 29 with the predetermined emergency stop plan when the subject vehicle 40 needs to be stopped urgently. Thus, the emergency stop plan is a driving plan selected in the absence of the cautious plan. The emergency stop plan is, for example, a driving plan for decelerating the subject vehicle 40 with the maximum deceleration until the subject vehicle 40 stops without changing the steering angle.

When the subject vehicle 40 needs to be stopped urgently, the path generation unit 27 may generate a driving plan for stopping the subject vehicle 40 urgently while preferably avoiding sudden deceleration. An example of an emergency stop plan is a driving plan that slows the subject vehicle 40 by keeping applying the maximum possible deceleration until the subject vehicle 40 stops. However, for the emergency stop, the maximum possible deceleration need not necessarily be kept as long as deceleration is started immediately in order to stop the subject vehicle 40.

Further, when the caution distance 41 is set, the emergency stop unit 282 repeatedly determines whether the subject vehicle is traveling while securing the caution distance 41. Then, the emergency stop unit 282 decelerates the subject vehicle when the vehicle-to-vehicle distance 44 decreases to be less than the caution distance 41, and controls the travel control ECU 31 so that the vehicle-to-vehicle distance 44 between the subject vehicle 40 and the surrounding vehicle 43 increases to be equal to or greater than the caution distance 41 (exceed the caution distance 41).

In addition, when the travel control ECU 31 is controlled to make the emergency stop by the emergency stop unit 282, the emergency stop unit 282 determines whether the subject vehicle would be able to travel with the set safety distance 42 if the driving plan newly generated by the path generation unit 27 is executed. Then, the emergency stop unit 282 controls the travel control ECU 31 to avoid performing the emergency stop and execute the newly generated driving plan when the subject vehicle is determined to be able to travel while ensuring the safety distance 42. Here, controlling the travel control unit may correspond to or include generating appropriate vehicle motion control requests.

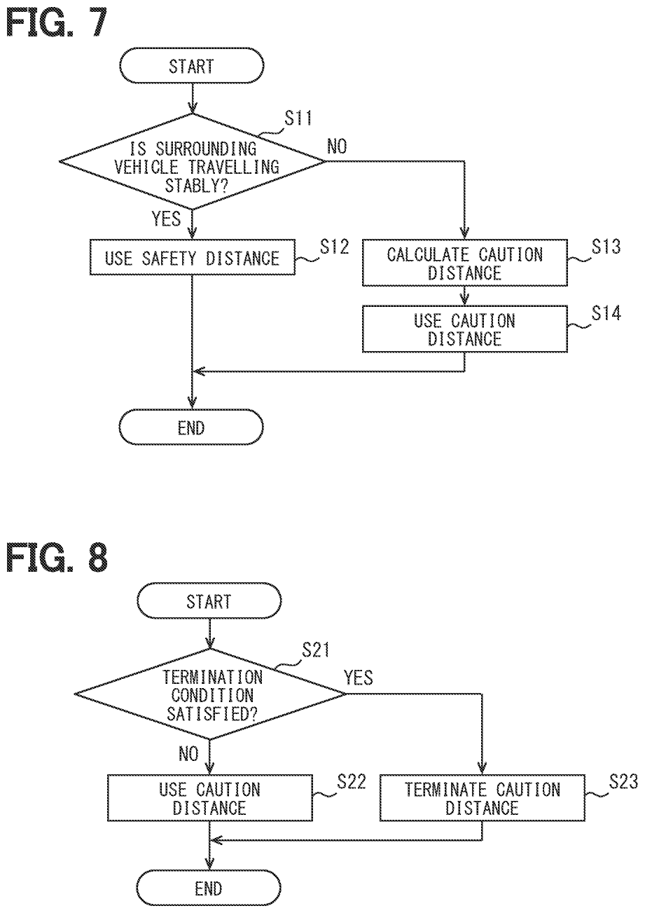

Next, processing by the vehicle control device 21 will be described with reference to the flow charts of FIGS. 7 to 11. Each flowchart is a process that is repeatedly executed in a short time while the vehicle control device 21 is on. For example, these processes are repeatedly executed in the same or shorter time as the safety determination period of the path checking unit 28.

First, the flowchart of FIG. 7 will be described. The flowchart shown in FIG. 7 is executed when the subject vehicle travels normally before the caution distance 41 is set. When the flowchart shown in FIG. 7 is started, at step S11, the caution distance determination unit 283 determines whether the surrounding vehicle 43 is traveling stably. If the surrounding vehicle is not traveling stably, the process proceeds to step S13. At step S12, since the surrounding vehicle 43 is traveling stably, the emergency stop unit 282 is controlled to select the cautious plan using the safety distance 42, and the process in the flowchart ends.

At step S13, since the surrounding vehicle 43 is not traveling stably, the caution distance setting unit 284 calculates the caution distance 41, and the process proceeds to step S14. As shown in FIG. 3, the caution distance 41 can be set in the longitudinal direction of the subject vehicle 40, that is, the direction along the road on which the subject vehicle 40 is traveling. In addition, as shown in FIG. 6, the caution distance 41 can also be set in the lateral direction of the subject vehicle 40, that is, in the road width direction. Therefore, at S11, it is determined whether the surrounding vehicle 43 is traveling stably in the direction along the road and in the width direction of the road.

The surrounding vehicle 43 includes a preceding vehicle. As for the preceding vehicle, it is determined whether the vehicle is traveling along the road stably. In addition, it may be determined whether the preceding vehicle is stable in the width direction of the road, in other words, whether the vehicle is swaying.

The surrounding vehicle 43 includes a right/left side vehicle traveling in a lane adjacent to the lane in which the subject vehicle 40 is traveling. As for the right/left side vehicle, it is determined whether the vehicle is traveling stably as to the road width direction (i.e., the lateral direction). In addition, it may be determined whether the right/left side vehicle is traveling stably along the road.

As described above, the caution distance 41 is provided when the calculation result of the safety distance 42 is not stable. Therefore, “whether the vehicle is traveling stably” at S11 is intended to determine whether the calculation result of the safety distance 42 is stable. A parameter that affects the safety distance 42 includes the speed and acceleration of the surrounding vehicle 43 and the vehicle-to-vehicle distance 44 to the preceding vehicle. Therefore, “whether the vehicle is traveling stably” at S11 can be determined by determining whether one or more parameters of the speed, acceleration, and vehicle-to-vehicle distance 44 of the surrounding vehicle 43 are stable. One example of a method for determining whether these parameters are stable is whether the amount of change or the rate of change of these parameters exceeds a threshold during a predetermined determination time. Here, the fact that the amount of change or the rate of change of the parameter exceeds the threshold may be an example that the current behavior of the preceding vehicle is not reasonably foreseeable.

At step S14, the caution distance 41 is set for the surrounding vehicle 43 that is not traveling stably. The caution distance 41 to be set includes a distance at least in the direction along the road and the width direction of the road for which the surrounding vehicle 43 is not determined to be traveling stably at S11. By setting the caution distance 41, the emergency stop unit 282 is controlled to select the semi-cautious plan using the caution distance 41, and the process in this flow ends.

The semi-cautious plan is a driving plan that secures the caution distance 41 to the target vehicle. The driving plan that secures the caution distance 41 is a driving plan in which the vehicle-to-vehicle distance 44 does not decrease to be shorter than the caution distance 41 when the vehicle-to-vehicle distance 44 is longer than the caution distance 41. The driving plan that secures the caution distance 41 is a driving plan that widens the vehicle-to-vehicle distance 44 when the vehicle-to-vehicle distance 44 is shorter than the caution distance 41.

Thus, when the surrounding vehicle 43 is stable, the driving plan using the safety distance 42 is selected, and when the surrounding vehicle 43 is not stable, the driving plan using the caution distance 41 is selected. In a situation where the vehicle speed of a preceding vehicle is unstable and the calculation result of the safety distance 42 is not stable, the safety distance 42 might be erroneously invaded. In view of this, by setting the caution distance 41 which serves as a buffer, it is possible to avoid a situation where the safety distance 42 of the subject vehicle 40 is invaded immediately.

At step S11 in FIG. 7, it is determined whether the surrounding vehicle 43 is traveling stably, but the determination is not limited to this. At step S11, it may be determined whether there is a curve in front of the preceding vehicle, and if there is a curve, the caution distance 41 may be set at steps S13 and S14. Since sudden braking on a curve is not particularly desirable, the caution distance 41 is provided before the preceding vehicle enters the curve, so that even if the preceding vehicle suddenly decelerates at the curve, it is possible to avoid a situation where the subject vehicle 40 is braked suddenly. Also, the caution distance 41 may be set when the curve has a radius that is larger than a predetermined radius.

Further, at step S11, it is determined whether there is a cause for extending the braking distance of the preceding vehicle, and if there is such a cause, the caution distance 41 may be set at steps S13 and S14. A situation where there is a cause for increasing the safety distance 42 ahead, for example, is one where the road surface changes from asphalt to cobblestone while traveling on a asphalt road. Since the braking distance tends to be extended on cobblestones as compared to asphalt, the safety distance 42 is also extended. If the road surface changes to cobblestone while the subject vehicle is traveling on asphalt, the safety distance 42 is extended, and therefore there is a risk that the preceding vehicle may suddenly violate the safety distance 42. Therefore, a caution distance 41 is set in advance to increase the vehicle-to-vehicle distance 44. As a result, even if the safety distance 42 suddenly increases, it is possible to handle this situation without executing the emergency stop plan.

Further, at step S11, it is determined whether the following formula (1) is satisfied, and if satisfied, the caution distance 41 may be set at steps S13 and S14.

{ls(t)−ls(t−1)}−{lv(t)−lv(t−1)}≥lth (1)

Here, lv(t) is the vehicle-vehicle distance 44 at time t, and ls(t) is the safety distance 42 at time t. For example, after the preceding vehicle has disappeared at a fork in the road, when another vehicle appears as another preceding vehicle, there is a possibility that the subject vehicle 40 will approach the preceding vehicle. At that time, a control input to shorten the vehicle-to-vehicle distance 42 and its result leads to expanding the safety distance 42. As a result, there is a possibility of sudden deceleration after sudden approach. In order to avoid such sudden deceleration after sudden approach, the caution distance 41 is set when the condition of formula (1) is satisfied. As a result, it is possible to avoid easily executing an emergency stop plan due to sudden approach.

Next, the flowchart of FIG. 8 will be described. The flowchart shown in FIG. 8 is executed when the caution distance 41 has been already set. When the process of the flowchart shown in FIG. 8 starts, the caution distance determination unit 283 determines whether a termination condition for terminating the setting of the caution distance 41 is satisfied at step S21. If satisfied, the process proceeds to step S23. If not satisfied, the process proceeds to step S22.

At step S22, since the termination condition is not satisfied, the emergency stop unit 282 is continuously controlled to select the semi-cautious plan using the caution distance 41, and the process in the flowchart ends. At step S23, since the termination condition is satisfied, the emergency stop unit 282 terminates the control using the caution distance 41 and is controlled to select the cautious plan using the safety distance 42, and the process in the flowchart ends.

In this way, since the setting of the caution distance 41 is terminated when the termination condition for terminating the setting of the caution distance 41 is satisfied, the caution distance 41 can be appropriately set only when it is necessary.

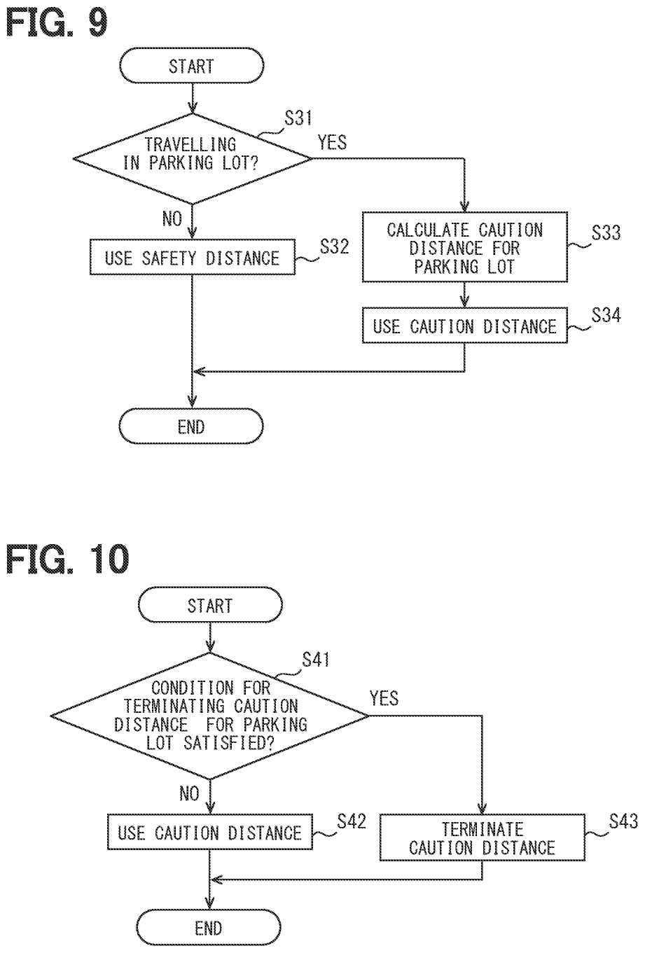

Next, the flowchart of FIG. 9 will be described. The flowchart shown in FIG. 9 is executed during normal traveling before the caution distance 41 is set. When the process of the flowchart shown in FIG. 9 starts, at step S31, the caution distance determination unit 283 determines whether the subject vehicle 40 is traveling in a parking lot, and if the subject vehicle is not traveling in the parking lot, the process proceeds to step S32. At step S32, since the subject vehicle is not traveling in the parking lot, the emergency stop unit 282 is controlled to select the cautious plan using the safety distance 42, and the process in the flowchart ends.

At step S33, since the subject vehicle is traveling in the parking lot, the caution distance setting unit 284 calculates the caution distance 41 for the parking lot, and the process proceeds to step S34. At step S34, the caution distance 41 is set for each of the subject vehicle 40 and the surrounding vehicle 43, and the emergency stop unit 282 is controlled to select a parking plan using the caution distance 41 that is designed for the parking lot. Then, the process in this flowchart ends. In this way, when the subject vehicle 40 is traveling in a parking lot, a traveling plan using the caution distance 41 designed for the parking lot is selected.

Next, the flowchart of FIG. 10 will be described. The flowchart shown in FIG. 10 is executed when the caution distance 41 for a parking lot has been already set. When the process of the flowchart shown in FIG. 10 starts, the caution distance determination unit 283 determines whether a termination condition for terminating the setting of the caution distance 41 for the parking lot is satisfied at step S41. If satisfied, the process proceeds to step S43. If not satisfied, the process proceeds to step S42.

At step S42, since the termination condition is not satisfied, the emergency stop unit 282 is continuously controlled to select the semi-cautious plan using the caution distance 41 for the parking lot, and the process in the flowchart ends. At step S43, since the termination condition is satisfied, the emergency stop unit 282 terminates the control using the caution distance 41 for the parking lot and is controlled to select the cautious plan using the safety distance 42, and the process in the flowchart ends.

In this way, since the setting of the caution distance 41 for the parking lot is terminated when the termination condition for terminating the setting of the caution distance 41 for the parking lot is satisfied, the caution distance 41 for the parking lot can be appropriately set only when it is necessary.

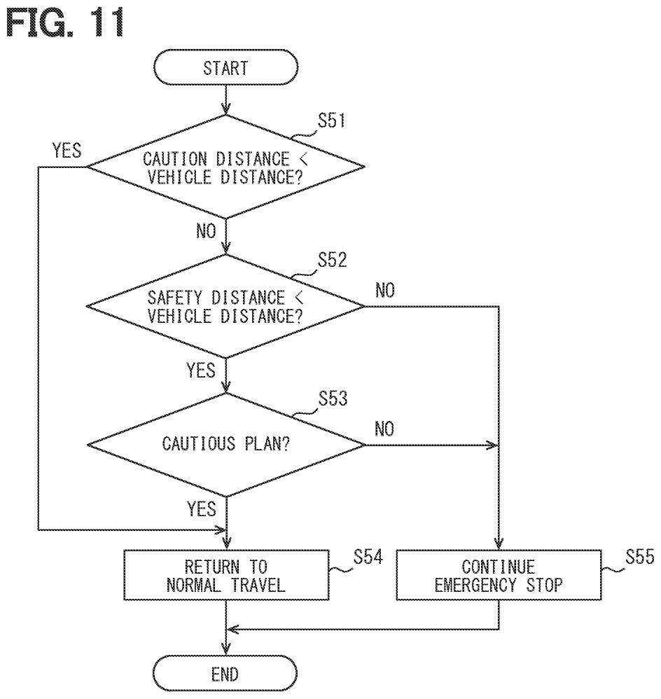

Next, the flowchart of FIG. 11 will be described. The flowchart shown in FIG. 11 is executed during execution of the emergency stop plan. When the process of the flowchart shown in FIG. 11 starts, it is determined whether the caution distance 41 is shorter than the vehicle-to-vehicle distance 44 at step S51. If the caution distance 41 is shorter than the vehicle-to-vehicle distance 44, the process proceeds to step S54. If not, the process proceeds to step S52.

At step S52, it is determined whether the safety distance 42 is shorter than the vehicle-to-vehicle distance 44. If the safety distance 42 is shorter than the vehicle-to-vehicle distance 44, the process proceeds to step S53. If not, the process proceeds to step S55. When executing step S53, the safety distance 42 has been secured. At step S53, it is determined whether a cautious plan is included in the driving plan given from the path generation unit 27. If the cautious plan is included, the process proceeds to step S54.

At step S54, since the caution distance 41 or the safety distance 42 is secured and the cautious plan exists, execution of the emergency plan is stopped, and normal traveling with the cautious plan is resumed. Then, the process terminates. At step S55, since the safety distance 42 is not secured or no cautious plan exists, execution of the emergency stop plan is continued, and the process terminates.

In this way, when a driving plan newly generated by the path generation unit 27 is executed during execution of the emergency stop plan, if a cautious plan that allows traveling while securing the safety distance 42 exists, execution of the emergency stop plan is terminated.

As described above, according to the vehicle control device in the present embodiment, the caution distance setting unit 284 sets the caution distance 41 as a distance to be kept between the subject vehicle and the surrounding vehicle 43. The caution distance 41 is a distance greater than the safety distance 42. Then, the emergency stop unit 282 controls the travel control ECU 31 to decelerate the subject vehicle when the subject vehicle cannot travel with the caution distance 41 such that the vehicle-to-vehicle distance 44 between the subject vehicle 40 and the surrounding vehicle 43 increases to be equal to or greater than the caution distance 41. Accordingly, if the vehicle-to-vehicle distance 44 between the subject vehicle and the surrounding vehicle 43 decreases to be less than the caution distance 41, the subject vehicle is decelerated to expand the vehicle-to-vehicle distance 44 without making an emergency stop. Therefore, even if the surrounding vehicle 43 repeats acceleration and deceleration due to unstable traveling state, for example, and even if the caution distance 41 is temporarily invaded, the vehicle-to-vehicle distance 41 can be expanded to be greater than the caution distance 41 by decelerating the subject vehicle without making an emergency stop. Therefore, it is possible to avoid making an unnecessary emergency stop.

Further, in this embodiment, the caution distance 41 is set for the surrounding vehicle 43 when the caution distance determination unit 283 determines that the caution distance 41 needs to be set for the surrounding vehicle 43. Therefore, the caution distance 41 can be set when it is necessary, and an unnecessary increase in the vehicle-to-vehicle distance 44 can be avoided.

Furthermore, in the present embodiment, the caution distance 41 is set for the surrounding vehicle 43 when the traveling state of the surrounding vehicle 43 is unstable. As a result, it is possible to keep an appropriate distance with respect to the surrounding vehicle 43 which is unstably traveling while avoiding making an unnecessary emergency stop.

If the caution distance 41 is not set, the calculation value of the safety distance 42 would constantly change greatly, and thus the control input of the subject vehicle 40 would not be stable. As a result, an emergency stop plan would be likely to be executed. On the contrary, by setting the caution distance 41 as described in the present embodiment, the caution distance 41 serves as a buffer for the emergency stop plan, and irregular acceleration/deceleration by a preceding vehicle does not directly affect the control input of the subject vehicle 40. As a result, the subject vehicle 40 can travel stably.

In this embodiment, setting of the caution distance 41 is terminated when a predetermined termination condition is satisfied. Therefore, it is possible to avoid unnecessarily setting the caution distance 41 when it is not necessary, and thus an unnecessary increase in the vehicle-to-vehicle distance 44 can be avoided.

Furthermore, in this embodiment, when the traveling state of the surrounding vehicle 43 is stabilized, setting of the caution distance 41 is terminated. Therefore, it is possible to avoid unnecessarily setting the caution distance 41 for the surrounding vehicle 43 which is stably traveling, and thus an unnecessary increase in the vehicle-to-vehicle distance 44 can be avoided.

In addition, according to the vehicle control device, when the driving plan newly generated by the path generation unit 27 is executed while the travel control ECU 31 is controlled to make the emergency stop by the emergency stop unit 282, the emergency stop unit 282 determines whether the subject vehicle can travel with the set safety distance 42 (S53). Then, the emergency stop unit 282 controls the travel control ECU 31 to avoid making the emergency stop and execute the newly generated driving plan when the subject vehicle can travel while ensuring the safety distance 42 (S54). As a result, even if the emergency stop is being executed, a new driving plan is executed when the safety distance 42 can be ensured. Therefore, it is possible to return back to normal traveling without the subject vehicle stopping completely. Therefore, even if the surrounding vehicle 43 is unstable and repeatedly accelerates and decelerates and the safety distance 42 is temporarily invaded, the vehicle-to-vehicle distance 44 is increased to ensure the safety distance 42 during deceleration by an emergency stop without the subject vehicle stopping completely. Therefore, the subject vehicle can continue to travel. Therefore, it is possible to avoid making an unnecessary emergency stop.

In addition, according to the present embodiment, when the driving plan newly generated by the path generation unit 27 is executed while the travel control ECU 31 is controlled to make the emergency stop, the emergency stop unit 282 determines whether the subject vehicle can travel with the set caution distance 41 (S51). Then, the travel control ECU 31 is controlled to avoid making the emergency stop and execute the newly generated driving plan if the subject vehicle is determined to be able to travel while ensuring the caution distance 41. As a result, even if the emergency stop is being executed, a new driving plan is executed if the caution distance 41 can be ensured. Therefore, it is possible to return back to safety traveling considering the caution distance 41 without the subject vehicle stopping completely.

### Second Embodiment

In the second embodiment, the method for calculating the cation distance 41 is different from the first embodiment. In the first embodiment, as a specific example of the calculation method of the caution distance 41, the variation distance due to the speed difference Δv is set as the offset distance Δd, and this offset distance Δd is added to the safety distance 42 to obtain the caution distance 41.

When S11 is NO, the caution distance 41 is calculated at S13. Therefore, surrounding vehicles are not traveling stably when the caution distance 41 is calculated. Therefore, the offset distance Δd calculated based on the speed difference Δv and the caution distance 41 calculated from the offset distance Δd may change over time.

When calculating the caution distance 41, the automated-driving unit 26 controls driving of the subject vehicle 40 so that the vehicle-to-vehicle distance 44 increases to be greater than the caution distance 41. Therefore, if the caution distance 41 changes, the vehicle-to-vehicle distance 44 is also longer or shorter than the caution distance 41 even if the vehicle-to-vehicle distance 44 does not change. Therefore, if the caution distance 41 changes greatly during a short time period, the subject vehicle 40 may travel unstably.

In view of the above, in the second embodiment, it is possible to avoid not only making an unnecessary emergency stop but also causing the subject vehicle 40 to travel unstably. In the second embodiment, once the caution distance 41 is calculated, the caution distance 41 is controlled to be less likely to be shortened. To be less likely to shorten the caution distance 41 may be an example of setting a stabilization condition to reduce a time instability of the safety envelope.

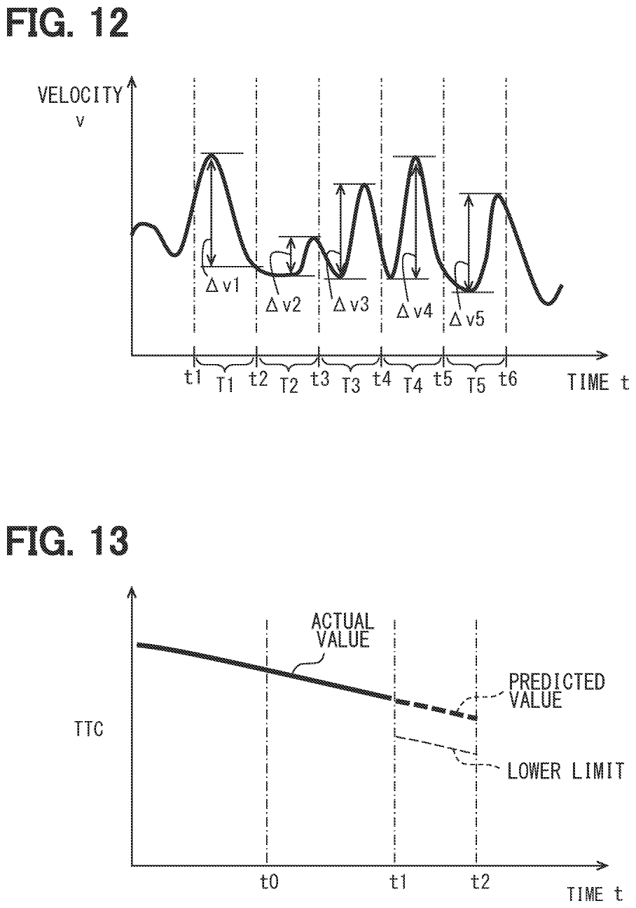

As one example, the speed difference Δv used to calculate the caution distance 41 is set to the maximum value of a plurality of sections in the past of the above-described unit observation time. Hereinafter, a specific description will be given with reference to FIG. 12. FIG. 12 conceptually shows changes in the velocity v of a preceding vehicle. In FIGS. 12, T1 to T5 are observation times T, and the length of each observation time T is a unit observation time. FIG. 12 also shows the velocity difference Δv at each observation time T. When the caution distance 41 is calculated using the speed difference Δv of each observation time T, the caution distance 41 also changes in proportion to the change in the speed difference Δv.

In view of this, in the second embodiment, the caution distance 41 used for generating a cautious plan is the maximum value of the speed differences Δv for a plurality of past sections. For example, suppose that the caution distance 41 is calculated using the maximum value of the speed differences Δv for the past three sections. In this case, even if the speed difference Δv2 and the speed difference Δv3 are calculated, since the speed difference Δv2 and the speed difference Δv3 are smaller than the speed difference Δv1, the speed difference Δv for calculating the caution distance 41 is still the speed difference Δv1. As a result, short-term changes in the caution distance 41 can be avoided.

### Third Embodiment

The third embodiment is similar to the second embodiment. The speed difference Δv is a unit time variation value, and in the second embodiment, the maximum value of the speed differences Δv for a plurality of past sections is used as the caution distance 41 that is used for generating the cautious plan. On the contrary, in the third embodiment, the average value of the speed differences Δv for the plurality of past sections is used as the caution distance 41 for generating the cautious plan. As with the second embodiment, short-term changes in the caution distance 41 can be avoided.

### Fourth Embodiment

As described in the first embodiment, the caution distance 41 may be set in a situation other than the situation where the surrounding vehicle is not traveling stably. For example, the caution distance 41 is set even when there is a large curve ahead or when there is a cause ahead for increasing the braking distance. The caution distance 41 set during these situations can also be a distance obtained by adding a predetermined additional distance (hereinafter, referred to as a fixed additional distance) to the safety distance 42. Note that the caution distance 41 calculated when the surrounding vehicle is determined not to travel stably may also be a distance obtained by adding the fixed additional distance to the safety distance 42.

However, if the caution distance 41 is a distance obtained by adding the fixed additional distance to the safety distance 42, the shorter/longer relationship between the vehicle-to-vehicle distance 44 and the caution distance 41 changes greatly for a short time period if the vehicle-to-vehicle distance 44 between the subject vehicle and a preceding vehicle 44 changes greatly over time. As a result, traveling of the subject vehicle 40 may become unstable.

Therefore, in the fourth embodiment, the caution distance 41 is defined as “safety distance+fixed additional distance+variation additional distance”. The variation additional distance is a distance that takes into account a change in the vehicle-to-vehicle distance. The change in the vehicle-to-vehicle distance 44 is also affected by changes in the speed and acceleration of a preceding vehicle. Therefore, the variation additional distance may also be a distance in consideration of the speed variation and acceleration variation of a preceding vehicle. Setting the variation additional distance may be an example of setting a stabilization condition to reduce a time instability of the safety envelope.

In the first embodiment, the caution distance 41 is obtained by adding an offset distance Δd considering the speed difference Δv of a preceding vehicle for the unit observation time to the safety distance 42. Therefore, the first embodiment may also be one aspect in which the fixed additional distance is set to zero.

An example of the distance that takes into consideration a change in the vehicle-to-vehicle distance is the offset distance Δd described in the first embodiment. Another example of the distance that takes into consideration a change in the vehicle-to-vehicle distance is one as described in the second embodiment. That is, in calculating the offset distance Δd, the distance is calculated using the maximum value of the speed differences Δv for a plurality of sections instead of using the speed difference Δv.

Another example of the distance that takes into consideration a change in the vehicle-to-vehicle distance is one as described in the third embodiment. That is, in calculating the offset distance Δd, the distance is calculated using the average value of the speed differences Δv for a plurality of sections instead of using the speed difference Δv.

### Fifth Embodiment

In the first embodiment, whether the surrounding vehicle 43 is traveling stably is determined based on whether the speed, acceleration, and vehicle-to-vehicle distance 44 of the surrounding vehicle 43 are stable. In the fifth embodiment, another method for determining whether the surrounding vehicle 43 is traveling stably will be described.

In the fifth embodiment, the frequency at which the surrounding vehicles 43 change lanes is used when determining whether the surrounding vehicle 43 is traveling stably. This is because a vehicle that often, repeatedly changes lanes cannot be a vehicle which is traveling stably.

For example, when the surrounding vehicle 43 changes lanes more than a predetermined number of times, such as three times, during a predetermined time period such as one minute or within a predetermined distance such as several hundred meters, the surrounding vehicle 43 is determined not to travel stably.

Of course, it is possible to determine whether the surrounding vehicle 43 is traveling stably based on not only the frequency of lane changes but also the conditions described in the first embodiment.

### Sixth Embodiment

In the sixth embodiment, further another method for determining whether a surrounding vehicle 43 is traveling stably will be described. In the sixth embodiment, when the speed-related value of the surrounding vehicle 43 exceeds a stable range, the surrounding vehicle 43 is determined not to travel stably.

If the speed of the surrounding vehicle 43 is unstable, it can be said that the surrounding vehicle 43 is traveling unstably. Therefore, it is determined whether the surrounding vehicle 43 is traveling stably based on a speed-related value. Specific examples of speed-related values include acceleration, which is a change in velocity over time, and jerk, which is a change in acceleration over time. The speed-related values also include a value obtained by dividing the speed by the vehicle-to-vehicle distance 44, that is, the time to collision (TTC).

The stable range is a range from the lower limit value to the upper limit value of the speed-related value. The stable range can be determined in advance based on experiments or the like for each specific speed-related value. The lower and upper limits of the stable range may be relative values with a speed-related value as a reference value (that is, zero) instead of absolute values.

Also, the reference value may be a predicted value of the speed-related value instead of the actual, current speed-related value. FIG. 13 shows the TTC and the lower limit of the stability range. It is no problem if TTC has a large value. Therefore, a range larger than the lower limit is the stable range.

The lower limit value at each time is a value obtained by subtracting a constant value from the predicted value at each time. It can be said that the stable range defined by the lower limit value is defined based on the predicted value.

Assume that time t1 is the current time. The TTC on the left side of time t1 is an actual measured value. The measured value means the TTC calculated based on the measured speed and vehicle-to-vehicle distance 44. The predicted value is a value predicted based on the actual measured values for a certain period of time in the past. The predicted value is, for example, a point on a straight line obtained by linearly approximating the actual measured values for a predetermined time in the past. As for the predicted value, in FIG. 13, the predicted value is calculated up to time t2. The past fixed time for calculating the predicted value may be the same as or different from the time for calculating the predicted value. In FIG. 13, the predicted value is calculated using the actual measured values from time t0 to time t1 The time from time t0 to time t1 is twice the time from time t1 to time t2. The predicted value and the lower limit value are updated at each predetermined period, such as the time length of the predicted value or half the time.

Even if the absolute value of the TTC calculated for the surrounding vehicle 43 is not so small, it is better to pay attention to the surrounding vehicle 43 if the decreasing rate of the TTC suddenly increases. By defining the stable range based on the predicted value in this way, the surrounding vehicle 43 can be determined to travel unstably when the decreasing rate of the TTC increases.

For pairs of speed-related values other than TTC, it is possible to determine whether the surrounding vehicle 43 is unstable by setting a stable range based on the predicted value.

### Seventh Embodiment

In the seventh embodiment, at S11, the condition for determining whether the surrounding vehicle 43 is traveling stably is set differently between when the caution distance 41 is set and when the caution distance 41 is not set.

Specifically, at S11, the caution distance determination unit 283 determines whether the surrounding vehicle 43 for which the caution distance 41 is not set is traveling stably by determining whether the speed-related value falls within a stable range or exceeds the stable range.

On the contrary, for the surrounding vehicle 43 for which the caution distance 41 has already been set, the caution distance determination unit 283 determines whether a speed-related value falls within the stable range for termination determination that is a range narrower than the stabile range for setting the caution distance 41. If the speed-related value is within the stable range for termination determination, setting of the caution distance 41 for the surrounding vehicle 43 is terminated.

By doing so, even when the travel-related value is close to the boundary of the stable range used for setting the caution distance 41, it is possible to avoid frequently setting and cancelling the caution distance 41 for the surrounding vehicle 43.

### Eighth Embodiment

In the first embodiment, the emergency stop unit 282 is described as an example of the emergency control unit. The emergency stop unit 282 controls the subject vehicle 40 to make an emergency stop when the safety distance 42 cannot be secured during traveling.

If the vehicle cannot travel with the safety distance 42, the driving plan cannot be adopted. Therefore, when it is not possible for the subject vehicle to travel while ensuring the safety distance 42, emergency control may be prepared in addition to the control according to the driving plan. Such emergency control may be a control other than the control which causes the subject vehicle 40 to stop urgently. For example, if the safety distance 42 can be ensured by changing the lane without following the driving plan, the control for changing lanes can be used as the control in an emergency situation. Also, the emergency control may be a control for sounding a horn. This is because, first, by sounding the horn, behavior of the surrounding vehicle 43 changes, and then there is a possibility that the safety distance 42 can be secured because of the behavior change of the surrounding vehicle 43.

### OTHER EMBODIMENTS

The present disclosure is not limited to the preferred embodiments of the present disclosure described above. Various modifications may be made without departing from the subject matters of the present disclosure.

It should be understood that the configurations described in the above-described embodiments are example configurations, and the present disclosure is not limited to the foregoing descriptions. The scope of the present disclosure encompasses claims and various modifications of claims within equivalents thereof.

In the first embodiment described above, the path checking device is implemented as the path checking unit 28, which is one of the functional blocks of the automated-driving unit 26, but the configuration is not limited to this. The path checking device may be realized by a control device different from the automated-driving unit 26.

In the first embodiment described above, the default of the safety distance 42 is calculated by a mathematical formula model, but the configuration is not necessarily limited to this. For example, the default of the safety distance 42 may be calculated by a method other than the mathematical model. For example, the safety distance setting unit 281 may be configured to calculate the safety distance 42 using information on the behavior of the subject vehicle 40 and a moving body around the subject vehicle 40 based on another index such as TTC (Time To Collision).

In the above-described first embodiment, a parking lot is taken as an example of a place of not-normal traveling, but the place of not-normal traveling is not limited to a parking lot. For example, such a place may be a site where slow driving or low-speed driving is compulsory.

In the above-described first embodiment, the functions realized by the vehicle control unit 21 may be realized by hardware and software different from those described above or by a combination of the hardware and the software. The vehicle control unit 21 may communicate with, for example, another control device, and the other control device may execute a part or all of the process. When the vehicle control unit 21 is realized by an electronic circuit, the output controller 30 may be realized by a digital circuit or an analog circuit, including a large number of logic circuits.

(Additional Remarks)

The present disclosure also includes the following technical ideas based on the above-described embodiments.

<Technical Aspect 1>

1. A path checking device (28) for a subject vehicle including a path generation unit (27) that generates a driving plan for the subject vehicle to travel by automated-driving and a travel control unit (31) that controls driving of the subject vehicle according to the driving plan, the path checking device comprising:

a safety distance setting unit (281) that is configured to set a minimum safety distance for the subject vehicle (40) to an obstacle in order for the subject vehicle to avoid closely approaching the obstacle;

a caution distance setting unit (284) that is configured to set a caution distance that is greater than the safety distance as a distance to be kept between the subject vehicle and a surrounding vehicle when the obstacle is the surrounding that is traveling around the subject vehicle; and

an emergency control unit that is configured to control the travel control unit to increase a vehicle-to-vehicle distance between the subject vehicle and the surrounding vehicle to exceed the caution distance when the caution distance is set for the surrounding vehicle and when the vehicle-to-vehicle distance is less than the caution distance, wherein

the emergency control unit is further configured to control the travel control unit to increase the vehicle-to-vehicle distance between the subject vehicle and the surrounding vehicle exceed the caution distance by executing a first driving plan when the driving plan generated by the path generation unit includes the first driving plan that is design to increase the vehicle-to-vehicle distance.

According to technical aspect 1, the first driving plan generated by the path generation unit can be used to increase the vehicle-to-vehicle distance.

<Technical Aspect 2>

2. The path checking device according to technical aspect 1, wherein the emergency control unit is further configured to execute a second driving plan when the driving plan generated by the path generation unit includes the second driving plan that is designed to maintain the vehicle-to-vehicle distance equal to or greater than the caution distance, when the caution distance is set for the surrounding vehicle, and when the vehicle-to-vehicle distance is equal to or greater than the caution distance.

According to technical aspect 2, the second driving plan generated by the path generation unit can be used to maintain the vehicle-to-vehicle distance equal to or greater than the caution distance.

1. A path checking device for a subject vehicle including a path generation unit that generates a driving plan for the subject vehicle to travel by automated-driving and a travel control unit that controls traveling of the subject vehicle according to the driving plan, the path checking device comprising:
a safety distance setting unit that is configured to set a minimum safety distance for the subject vehicle to an obstacle in order for the subject vehicle to avoid closely approaching the obstacle;
an emergency control unit that is configured to:
determine whether the subject vehicle is traveling with the safety distance; and
execute emergency control for the subject vehicle that is different from normal control according to the driving plan when a distance between the subject vehicle and the obstacle is less than the safety distance; and
a caution distance setting unit that is configured to set a caution distance for the subject vehicle to a surrounding vehicle that is travelling around the subject vehicle when the obstacle is the surrounding vehicle, the caution distance being greater than the safety distance, wherein
the emergency control unit is further configured to:
determine whether the subject vehicle is traveling with the caution distance; and
control the travel control unit to increase a distance from the subject vehicle to the surrounding vehicle to be equal to or greater than the caution distance when the distance from the subject vehicle to the surrounding vehicle is less than the caution distance.

2. The path checking device according to claim 1, wherein
the caution distance setting unit is further configured to set the caution distance to be greater than or equal to a distance that is a sum of the safety distance and a variation additional distance, and
the variation additional distance is determined based on a time variation of the distance from the subject vehicle to the surrounding vehicle.

3. The path checking device according to claim 2, wherein
the caution distance setting unit is further configured to calculate the variation additional distance using a plurality of unit time variation values,
each of the plurality of unit time variation values varies according to a variation in the distance from the subject vehicle to the surrounding vehicle for each predetermined unit observation time, and
the variation additional distance calculated using the plurality of unit time variation values has a less time variation than the variation additional distance calculated using a single unit time variation value.

4. The path checking device according to claim 1, further comprising
a caution distance determination unit that is configured to determine whether to set the caution distance for the surrounding vehicle when the safety distance temporarily increases or when the safety distance will increase, wherein
the caution distance setting unit is configured to set the caution distance for the surrounding vehicle when the caution distance determination unit determines to set the caution distance for the surrounding vehicle.

5. The path checking device according to claim 4, wherein
the caution distance determination unit is further configured to determine to set the caution distance for the surrounding vehicle when a traveling state of the surrounding vehicles is unstable.

6. The path checking device according to claim 5, wherein
the caution distance determination unit is further configured to determine to set the caution distance for the surrounding vehicle when at least one of the traveling state of the surrounding vehicle in a road direction and the traveling state of the surrounding vehicle in a lateral direction is unstable.

7. The path checking device according to claim 6, wherein
the caution distance determination unit is further configured to determine whether the traveling state of the surrounding vehicle in the lateral direction is stable considering a frequency of lane changes performed by the surrounding vehicle.

8. The path checking device according to claim 5, wherein
the caution distance determination unit is configured to determine that the traveling state of the surrounding vehicle is unstable when a speed-related value determined from a speed or an acceleration of the surrounding vehicle exceeds a stable range.

9. The path checking device according to claim 8, wherein
the speed-related value is a time to collision against the surrounding vehicle.

10. The path checking device according to claim 8, wherein
the speed-related value is a time change in speed of the surrounding vehicle or a time change in acceleration of the surrounding vehicle.

11. The path checking device according to claim 8, wherein
the stable range is a range based on a predicted speed-related value that is determined from a changing trend of the speed-related value.

12. The path checking device according to claim 4, wherein
the caution distance determination unit is further configured to determine whether to terminate setting the caution distance for the surrounding vehicle for which the caution distance has already been set when the safety distance subsequently stabilizes or when the safety distance will stabilize, and
the caution distance setting unit is further configured to terminate setting the caution distance for the surrounding vehicle when the caution distance determination unit determines to terminate setting the caution distance for the surrounding vehicle.

13. The path checking device according to claim 12, wherein
the caution distance determination unit is further configured to determine to terminate setting the caution distance for the surrounding vehicle when the driving state of the surrounding vehicle for which the caution distance has already been set is stable.

14. The path checking device according to claim 8, wherein
the caution distance determination unit is further configured to determine to terminate setting the caution distance for the surrounding vehicle when the speed-related value of the surrounding vehicle for which the caution distance has already been set is within a narrower stable range than the stable range at a timing of setting the caution distance.

15. A path checking device for a subject vehicle including a path generation unit that generates a driving plan for the subject vehicle to travel by automated-driving and a travel control unit that controls driving of the subject vehicle according to the driving plan, the path checking device comprising:
a safety distance setting unit that is configured to set a minimum safety distance for the subject vehicle to an obstacle in order for the subject vehicle to avoid closely approaching the obstacle; and
an emergency control unit that is configured to:
determine whether the subject vehicle is traveling with the safety distance; and
execute emergency control for the subject vehicle that is different from normal control according to the driving plan when a distance from the subject vehicle to the obstacle is less than the safety distance, wherein
the emergency control unit is further configured to:
determine whether the subject vehicle is traveling with the safety distance when executing the driving plan newly generated by the path generation unit while executing the emergency control; and
control the travel control unit to terminate the emergency control and execute the newly generated driving plan when the subject vehicle is determined to be traveling with the safety distance.

16. The path checking device according to claim 15, further comprising
a caution distance setting unit that is configured to set a caution distance for the subject vehicle to a surrounding vehicle that is travelling around the subject vehicle when the obstacle is the surrounding vehicle, the caution distance being greater than the safety distance, wherein
when the caution distance has been already set for the surrounding vehicle, the emergency control unit is configured to determine whether the subject vehicle would be able to travel with the safety distance if the driving plan newly generated by the path generation unit is executed during execution of the emergency control; and
the emergency control unit is further configured to control the travel control unit to terminate the emergency control and execute the newly generated driving plan when the subject vehicle is determined to be able to travel with the safety distance.

17. A path checking method executed by a processor for a subject vehicle that travels according to a driving plan that is set for the subject vehicle to travel by automated-driving, the method comprising:
setting a minimum safety distance for the subject vehicle to an obstacle in order for the subject vehicle to avoid closely approaching the obstacle;
determining whether the subject vehicle is traveling with the safety distance;
executing emergency control for the subject vehicle that is different from normal control according to the driving plan when a distance from the subject vehicle to the obstacle is less than the safety distance;
setting a caution distance for the subject vehicle to a surrounding vehicle that is travelling around the subject vehicle when the obstacle is the surrounding vehicle, the caution distance being greater than the safety distance;
determining whether the subject vehicle is travelling with the caution distance; and
controlling the travel control unit to increase a distance from the subject vehicle to the surrounding vehicle to exceed the caution distance when the distance from the subject vehicle to the surrounding vehicle is less than the caution distance.

18. A path checking method executed by a processor for a subject vehicle that travels according to a driving plan that is set for the subject vehicle to travel by automated-driving, the method comprising:
setting a minimum safety distance for the subject vehicle to an obstacle in order for the subject vehicle to avoid closely approaching the obstacle;
determining whether the subject vehicle is traveling with the safety distance;
executing emergency control for the subject vehicle that is different from normal control according to the driving plan when a distance from the subject vehicle to the obstacle is less than the safety distance;
determining whether the subject vehicle would be able to travel with the safety distance if the driving plan that is newly generated is executed during execution of the emergency control; and
terminating the emergency control and executing the newly generated driving plan when the subject vehicle is determined to be able to travel with the safety distance.

19. A vehicle control method executed by a processor for a subject vehicle that travels according to a driving plan that is set for the subject vehicle to travel by automated-driving, the method comprising:
setting a safety envelope as a condition for the subject vehicle to perform a proper response to an obstacle to maintain a predetermined level of risk;
determining whether a current behavior of the obstacle is reasonably foreseeable; and
setting a stabilization condition to reduce a time instability of the safety envelope when the current behavior of the obstacle is not reasonably foreseeable.
